(19) United States
(12) Patent Application Publication
(10) Pub. No.: US 2023/0401798 A1
(43) Pub. Date: Dec. 14, 2023

(54) ACCESSIBLE MIXED REALITY APPLICATIONS

(71) Applicant: Apple Inc., Cupertino, CA (US)

(72) Inventors: Jeffrey Philip BIGHAM, Pittsburgh, PA (US); Jaylin HERSKOVITZ, Ann Arbor, MI (US); Samuel WHITE, Pittsburgh, PA (US); Jason WU, Pittsburgh, PA (US)

(21) Appl. No.: 18/239,018

(22) Filed: Aug. 28, 2023

Related U.S. Application Data
(62) Division of application No. 17/131,349, filed on Dec. 22, 2020, now abandoned.
Application No. 17/131,349 is a continuation of application No. 16/830,870, filed on Mar. 26, 2020, now abandoned.
(60) Provisional application No. 62/891,863, filed on Aug. 26, 2019.

(51) Int. Cl. G06T 19/00; G06F 3/16; G06T 19/20

(52) U.S. Cl. CPC G06T 19/006; G06F 3/165; G06T 19/20; G06T 2219/2004; G06T 2200/24

(57) ABSTRACT

An example process for placing virtual objects in an environment includes: displaying a first view of the environment, the first view including a virtual object displayed at a first location on a first surface of the environment, the first location corresponding to a current location of the electronic device; detecting movement of the electronic device from the current location to an updated location; in accordance with detecting the movement from the current location to the updated location: displaying a second view of the environment, the second view including the virtual object displayed at a second location on the first surface of the environment, the second location corresponding to the updated location; and receiving user input to place the virtual object; and in response to receiving the user input, placing the virtual object at the second location.

### CROSS-REFERENCE TO RELATED APPLICATIONS

This application is a divisional of U.S. patent application Ser. No. 17/131,349, entitled ACCESSIBLE MIXED REALITY APPLICATIONS, filed on Dec. 22, 2020, which is a continuation of U.S. patent application Ser. No. 16/830,870, entitled ACCESSIBLE MIXED REALITY APPLICATIONS, filed on Mar. 26, 2020, which claims priority to U.S. Provisional Application No. 62/891,863, entitled ACCESSIBLE MIXED REALITY APPLICATIONS, filed on Aug. 26, 2019. The entire contents of each of these applications are hereby incorporated by reference in their entireties.

### FIELD

The present disclosure relates generally to mixed reality software applications accessible to disabled users, such as visually impaired users or users having limited mobility.

### BACKGROUND

Current mixed reality software applications may have limited to no accessibility for disabled users. For example, existing applications often require users to view a display or physically move around to provide a satisfactory experience. Further, current accessibility features for computing devices, such as Apple Inc.'s VoiceOver and Switch Control, may be incompatible with or not implemented in such software applications. Accordingly, techniques for improving the accessibility of mixed reality software applications are desirable.

### BRIEF SUMMARY

An example process for placing virtual objects in an environment includes: at an electronic device with one or more processors and memory: displaying a first view of the environment, the first view including a virtual object displayed at a first location on a first surface of the environment, the first location corresponding to a current location of the electronic device; detecting movement of the electronic device from the current location to an updated location; in accordance with detecting the movement from the current location to the updated location: displaying a second view of the environment, the second view including the virtual object displayed at a second location on the first surface of the environment, the second location corresponding to the updated location; and receiving user input to place the virtual object; and in response to receiving the user input, placing the virtual object at the second location.

Displaying the first and the second views including the virtual object at the respective locations may allow a virtual object's location to correspond to a device's physical location. Having a virtual object's location correspond to a physical location may improve the accessibility of mixed reality software applications involving placing virtual objects. For example, it may be undesirable for a visually impaired user to select a location on a displayed representation of an environment to place a virtual object. This may be because a displayed location is not meaningful to a visually impaired user, as the user may be unaware of a displayed location relative to the environment (or relative to other objects in the environment). Thus, corresponding a virtual object's location to a physical location (and placing a virtual object near a device's physical location) may meaningfully indicate the location of a virtual object, as to visually impaired users, physical locations may be more meaningful than displayed locations. In this manner, the user-device interface is made more efficient and accessible (e.g., by allowing visually impaired users to interact with mixed reality applications, by meaningfully indicating a virtual object's location, by improving the accuracy of virtual object placement), which additionally reduces power usage and improves battery life of the device by enabling the user to use the device more quickly and efficiently.

An example process for locating virtual object includes: at an electronic device with one or more processors and memory: detecting a virtual object; in response to detecting the virtual object, providing an audio output indicating an identity of the virtual object and a distance between the virtual object and the electronic device; after providing the audio output: detecting movement of the electronic device; determining, based on the detected movement of the electronic device, that the electronic device is within a predetermined distance of the virtual object; and in accordance with determining that the electronic device is within the predetermined distance of the virtual object, providing an output indicating that the virtual object has been located.

Providing the audio outputs discussed above (e.g., in response to detecting a virtual object and in accordance with determining that the electronic device is within the predetermined distance of the virtual object) may improve the accessibility of mixed reality software applications involving locating virtual objects. For example, the audio output indicating the identity of the virtual object and the distance between the virtual object and the electronic device may guide a visually impaired user to the virtual object and increase awareness of the virtual object's location relative to the user. Similarly, providing the audio output indicating that the virtual object has been located may indicate that a user is near (or at) the virtual object's location, thereby increasing awareness of the virtual object's location. In this manner, the user-device interface is made more efficient and accessible (e.g., by allowing visually impaired users to interact with mixed reality applications, by enabling visually impaired users to locate virtual objects, by improving the accuracy and efficiency of locating virtual objects), which additionally reduces power usage and improves battery life of the device by enabling the user to use the device more quickly and efficiently.

An example process includes: displaying a first view of a mixed reality (MR) environment, the first view corresponding to a first pose of the electronic device; while displaying the first view, receiving user input to maintain the first view; in response to receiving the user input, maintaining the first view when the electronic device moves from the first pose to a second pose; detecting first movement of the electronic device from the second pose to a third pose; determining a virtual pose of the electronic device based on the first movement of the electronic device relative to the first pose; and updating the first view to display a second view of the MR environment, the second view corresponding to the virtual pose.

Maintaining the first view when the electronic device moves from the first pose to a second pose may improve the accessibility of exploring a MR environment. For example, without maintaining the first view, the first view may be otherwise difficult or cumbersome to sustain, e.g., as displaying the first view may require a user to hold an uncomfortable first pose. Thus, maintaining the first view when the electronic device moves to a (potentially more comfortable or accessible) second pose may allow comfortable and convenient interaction with the first view. Similarly, displaying the second view corresponding to the virtual pose may allow comfortable and convenient exploration of a MR environment based on movement from a (potentially more comfortable or accessible) second pose. Such techniques may thus be desirable for users with limited mobility and visually impaired users, as it may be difficult for such users to hold a particular pose corresponding to MR content of interest. In this manner, the user-device interface is made more efficient and accessible (e.g., by allowing visually impaired users and users with limited mobility to comfortably and conveniently explore MR environments, by presenting MR content of interest when users are in comfortable positions, by reducing repeated inputs to comfortably view MR content of interest), which additionally reduces power usage and improves battery life of the device by enabling the user to use the device more quickly and efficiently.

While the above describes example accessibility benefits that may be provided by the techniques discussed herein, one of skill in the art will appreciate that such techniques may provide additional advantages over prior systems and techniques. For example, the potential benefits may not be limited to accessibility use cases, as such techniques may also be desirable when visual, haptic, and/or movement based interaction with an electronic device is unavailable or undesirable (e.g., when the user is driving, walking, laying down, etc.)

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1 is a block diagram illustrating a multifunction device with a touch-sensitive display in accordance with some embodiments.

FIG. 2 illustrates a multifunction device having a touch screen in accordance with some embodiments.

FIGS. 3A-B illustrate systems and environments for providing accessible mixed reality (MR) applications, according to some embodiments.

FIGS. 4A-D illustrate accessible techniques for scanning a MR environment, according to some embodiments.

FIGS. 4E-K illustrate accessible techniques for placing virtual objects in a MR environment, according to some embodiments.

FIGS. 5A-C illustrate further accessible techniques for placing virtual objects in a MR environment, according to some embodiments.

FIGS. 6A-F illustrate accessible techniques for locating virtual objects in a MR environment, according to some embodiments.

FIGS. 7A-C illustrate further accessible techniques for locating virtual objects in a MR environment, according to some embodiments.

FIGS. 8A-B illustrate accessible techniques for exploring a MR environment, according to some embodiments.

FIGS. 9A-C illustrate accessible techniques for maintaining and updating a view of a MR environment, according to some embodiments.

FIG. 10 illustrates a flow diagram of a process for scanning a MR environment and for placing virtual objects in a MR environment, according to some embodiments.

FIG. 11 illustrates a flow diagram of a process for locating virtual objects in a MR environment, according to some embodiments.

FIG. 12 illustrates a flow diagram of a process for maintaining and updating a view of a MR environment, according to some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

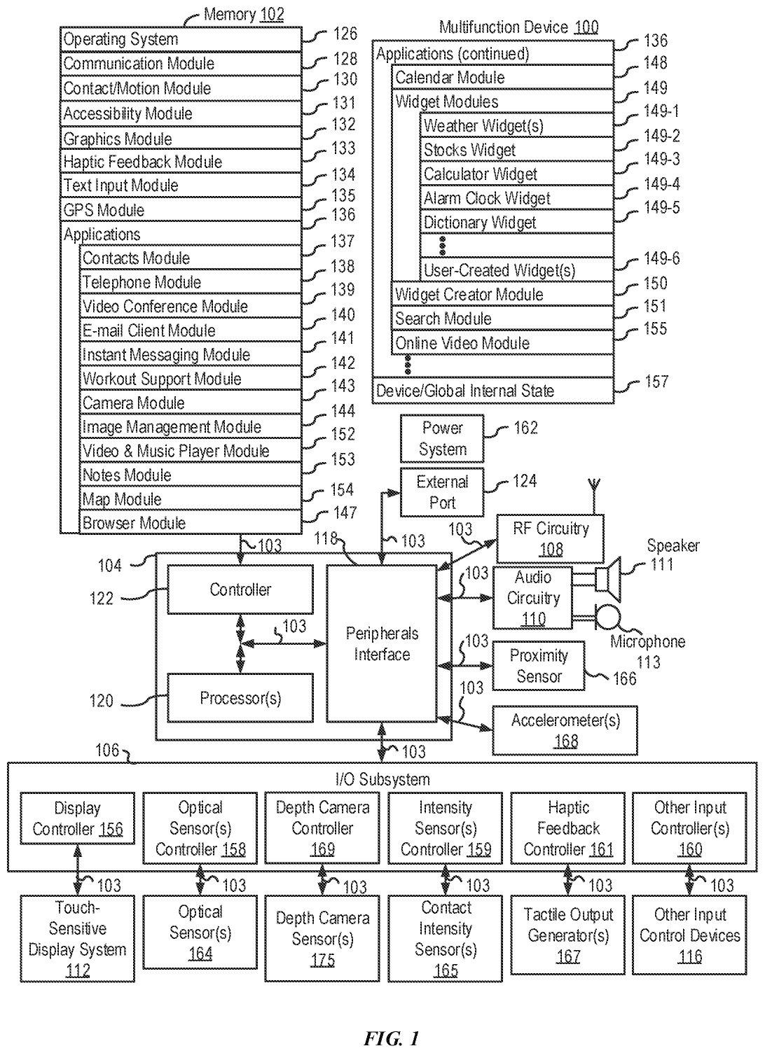

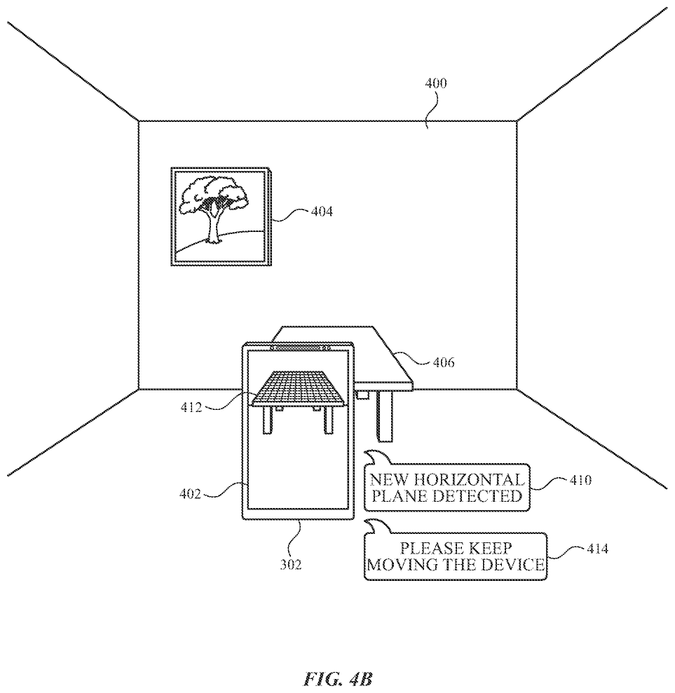

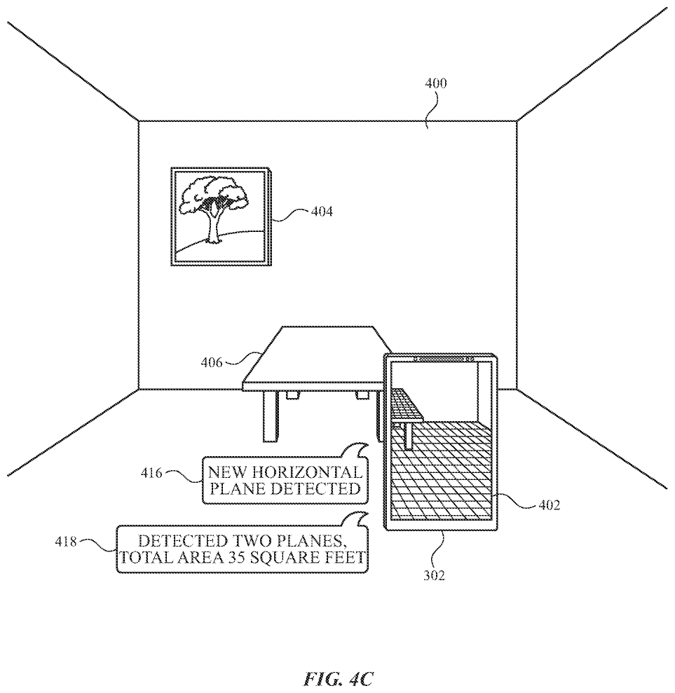

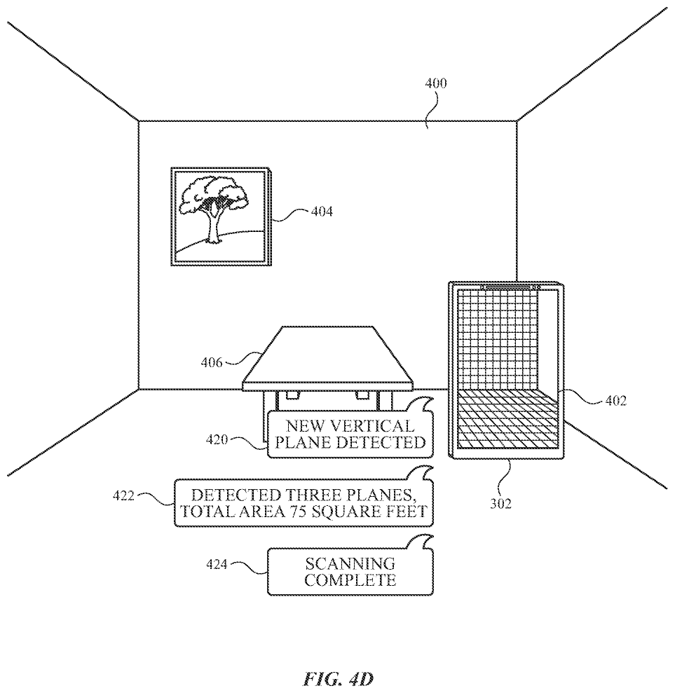

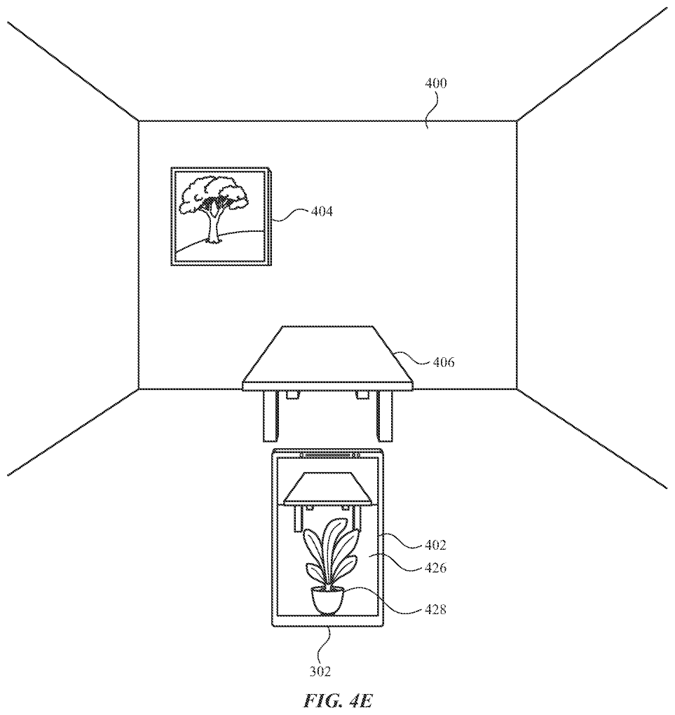

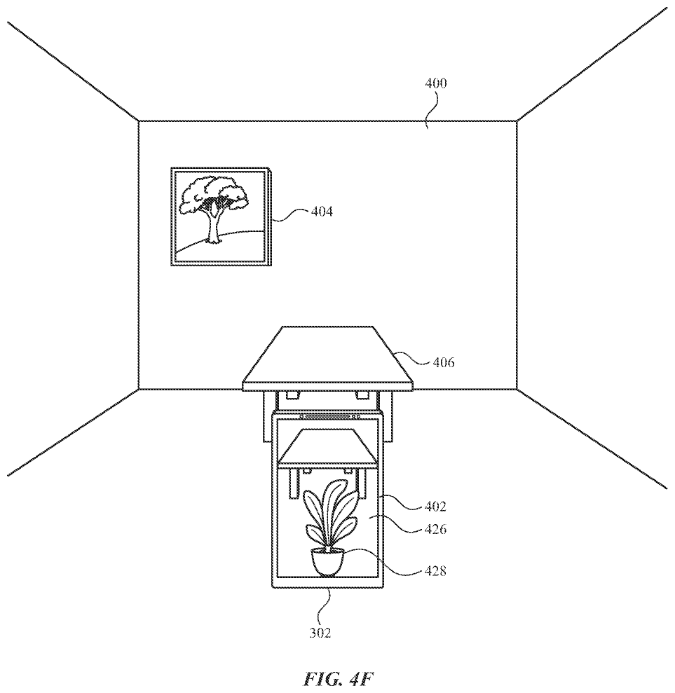

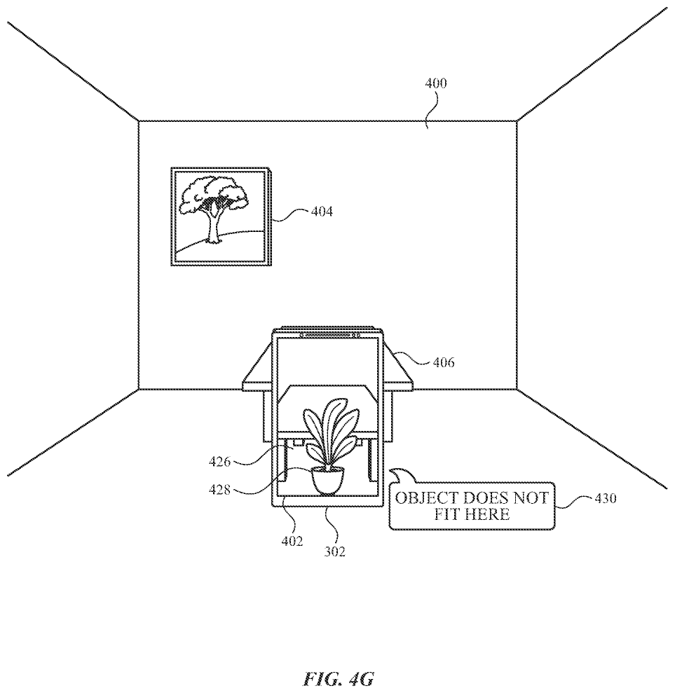

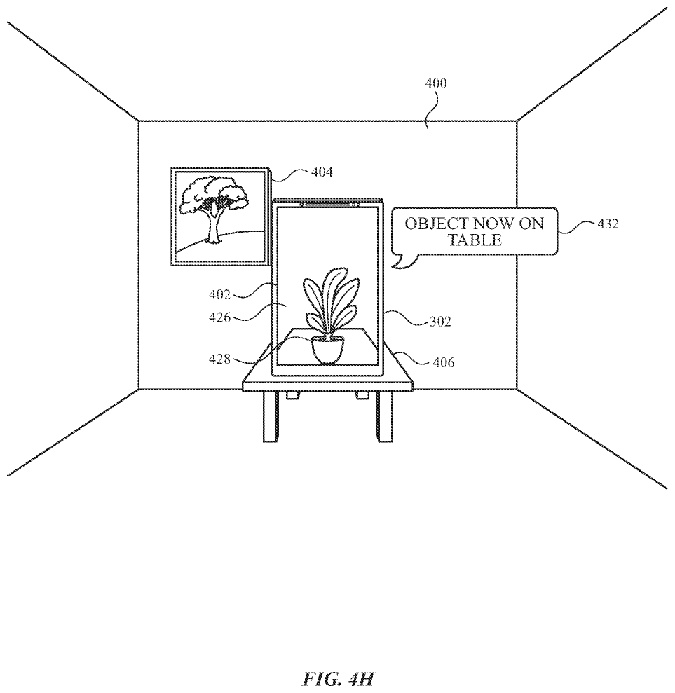

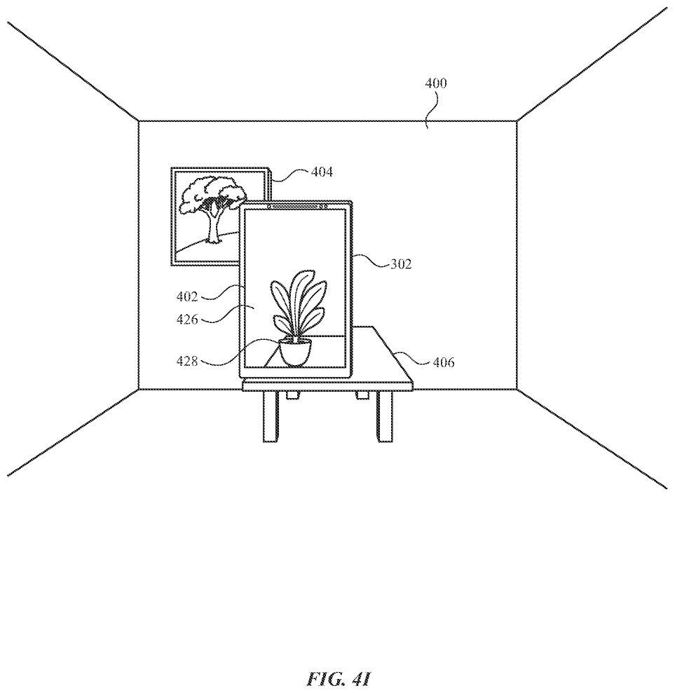

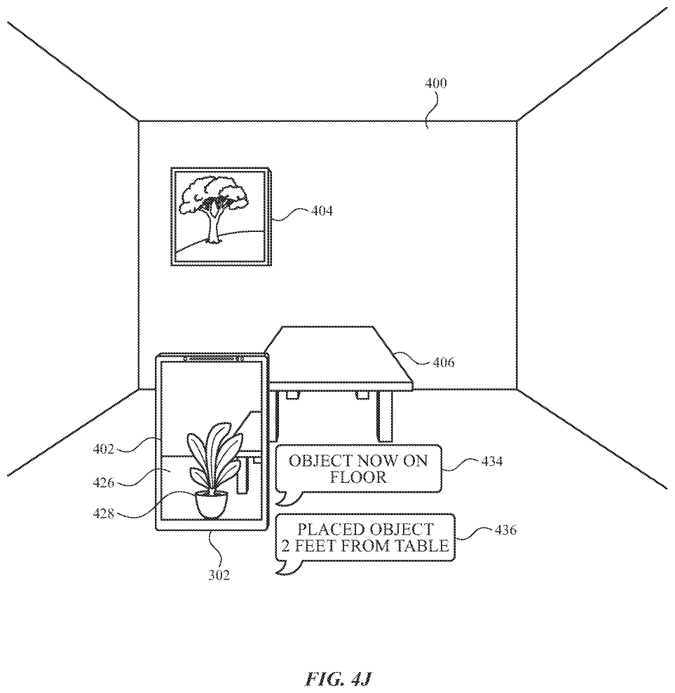

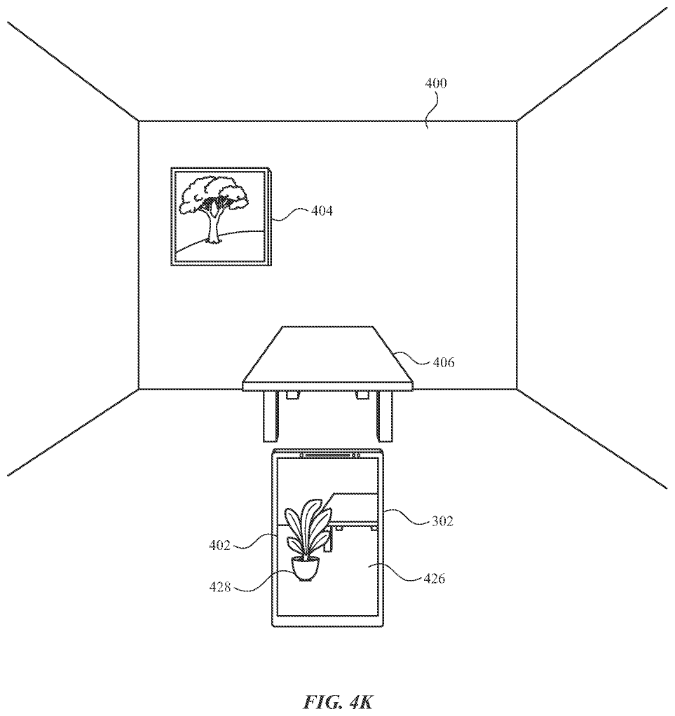

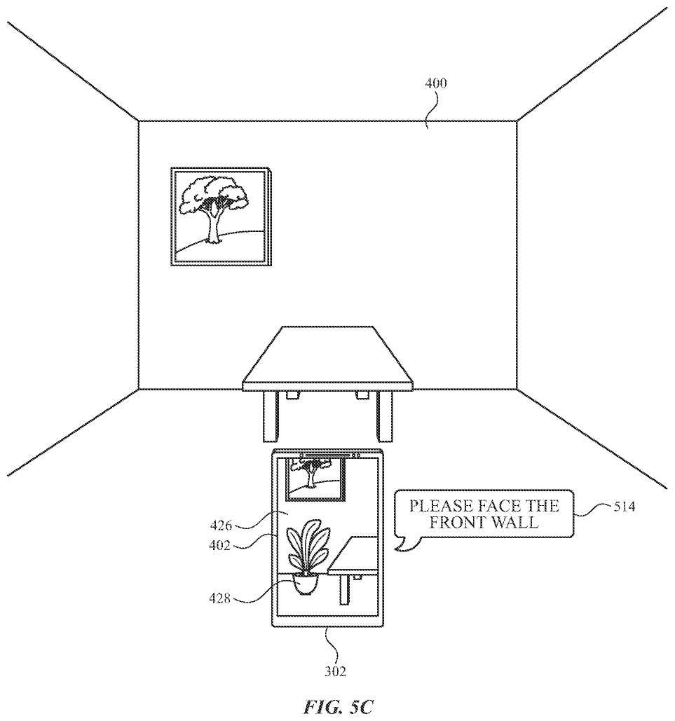

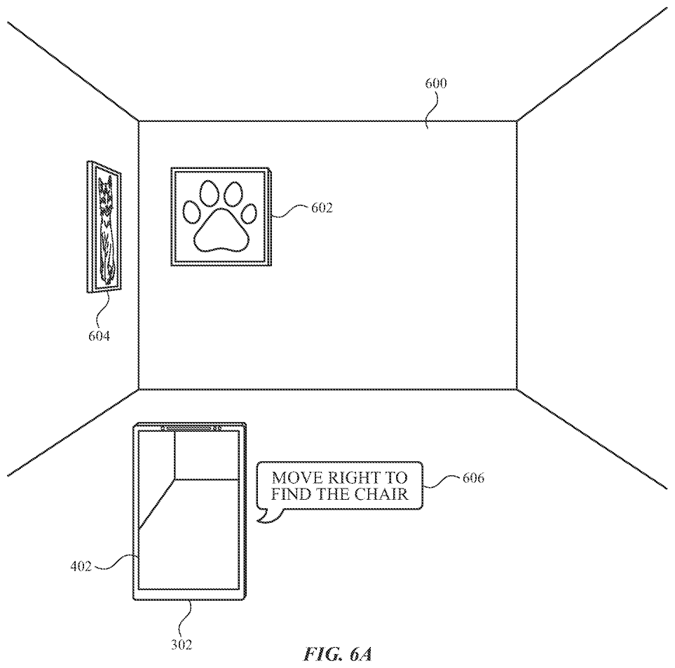

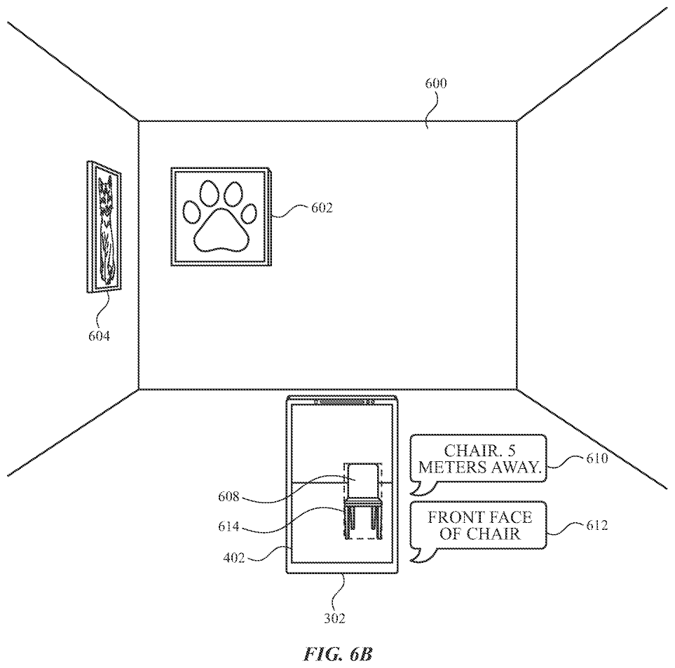

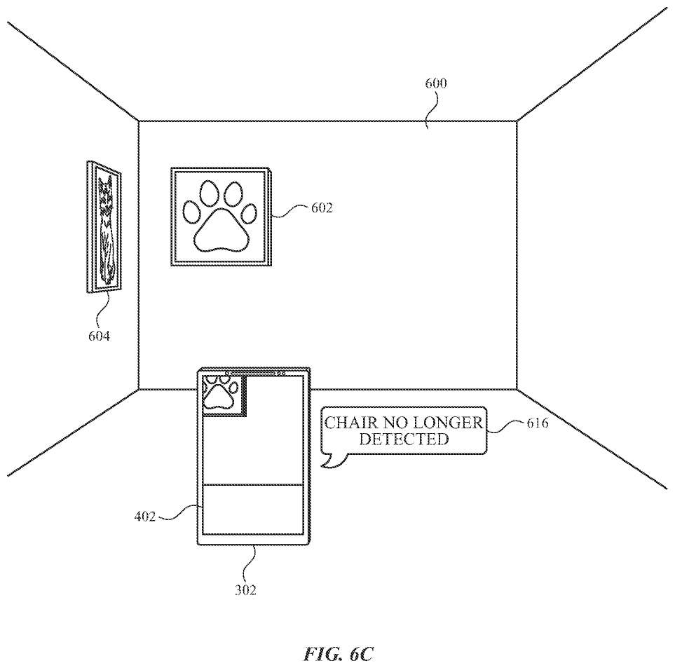

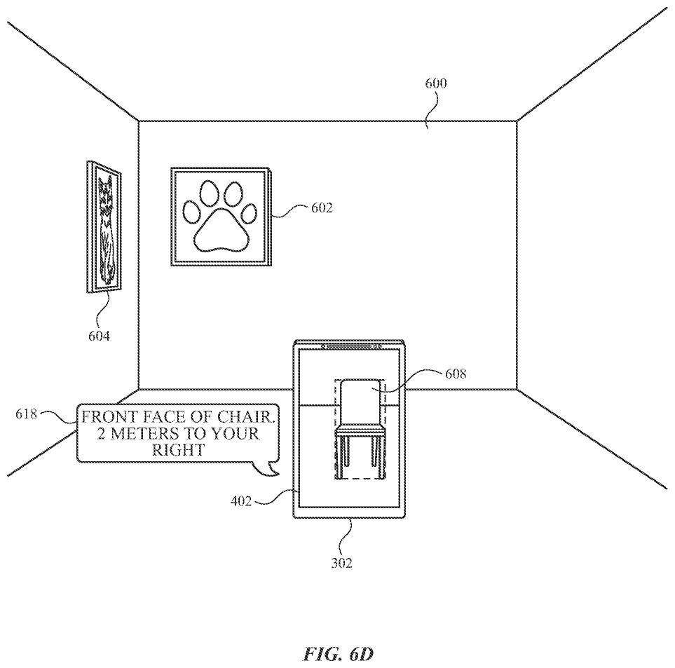

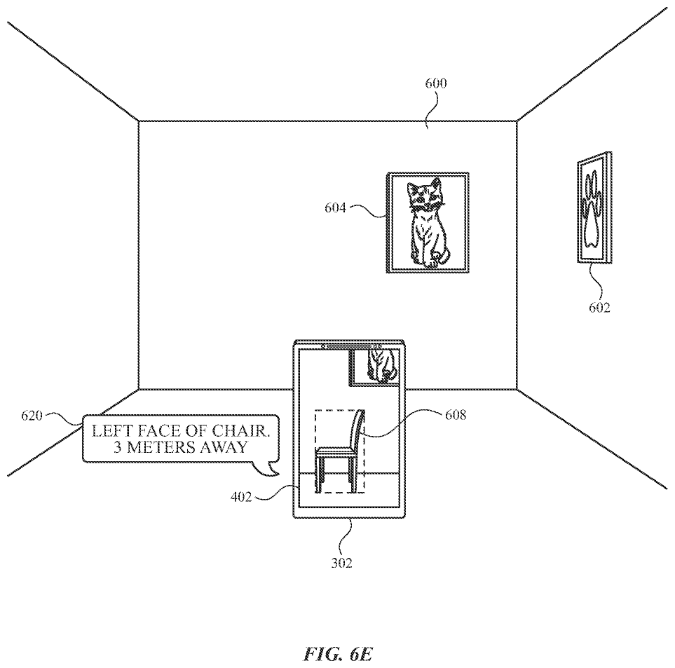

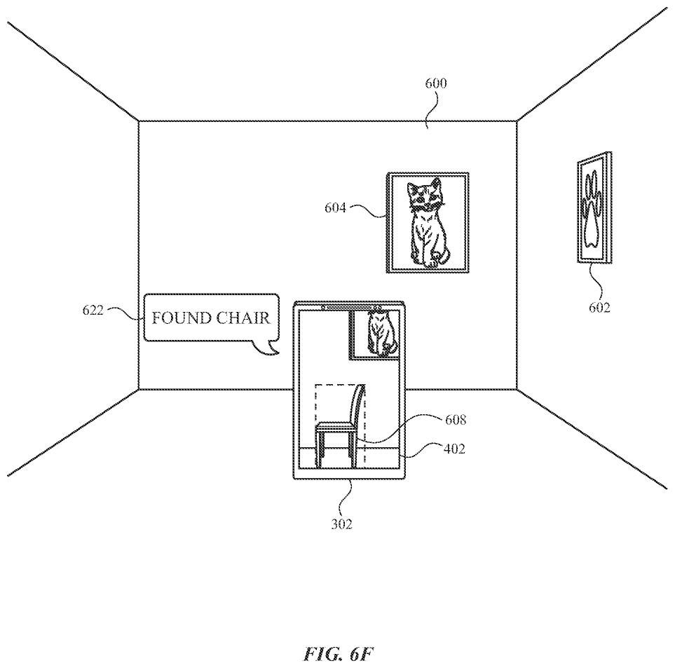

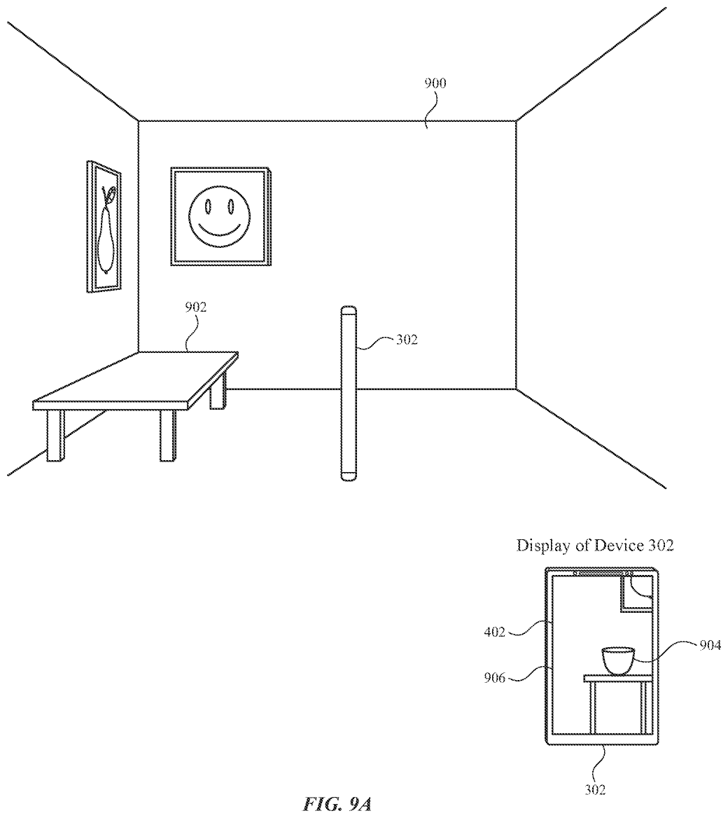

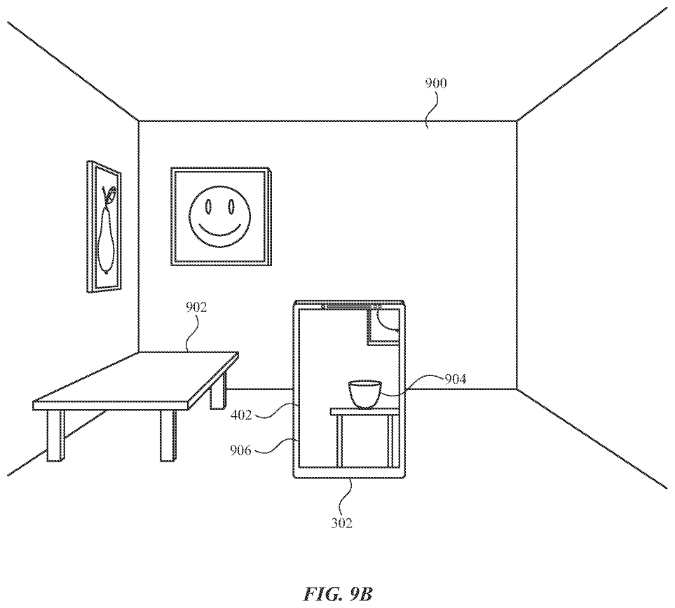

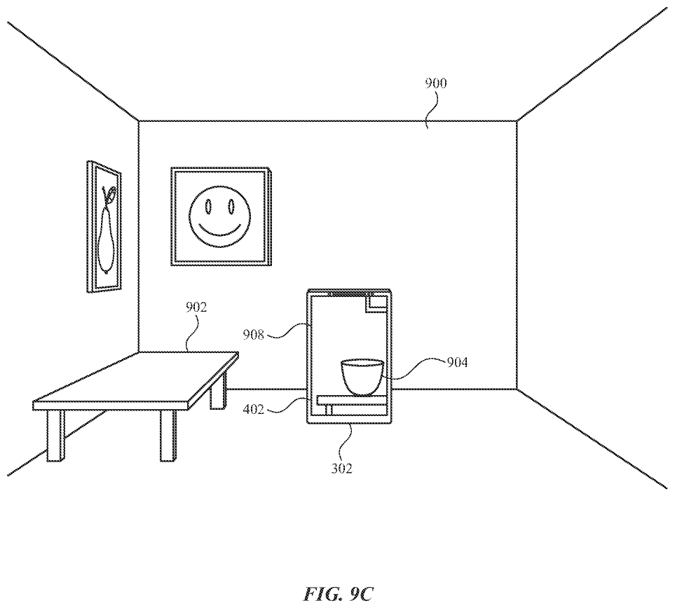

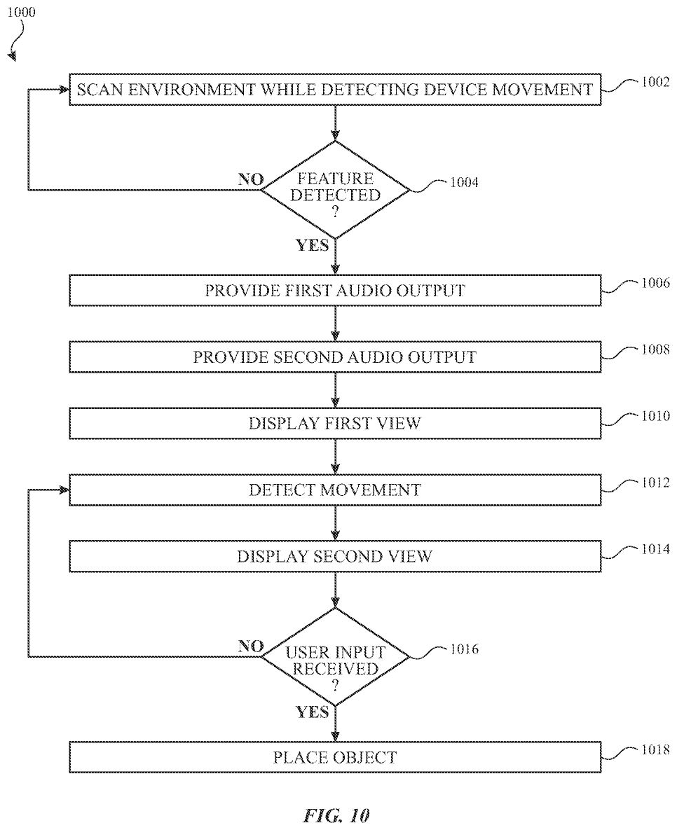

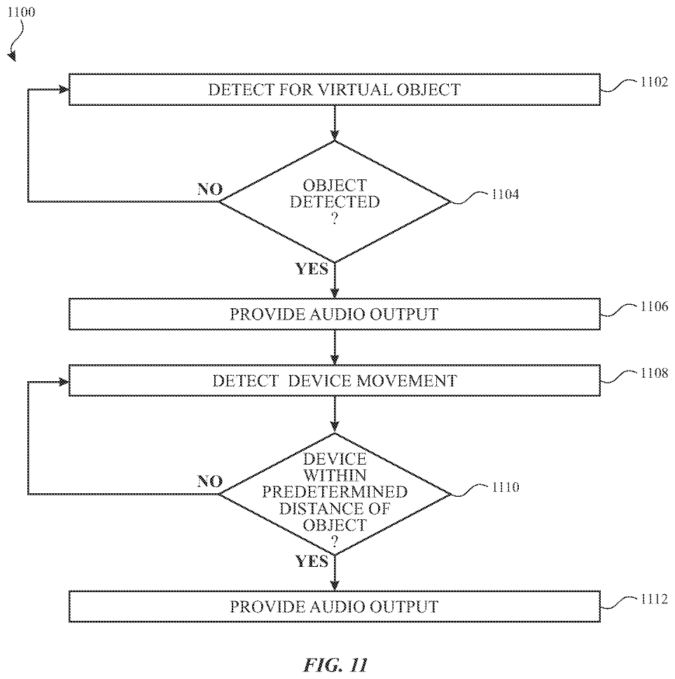

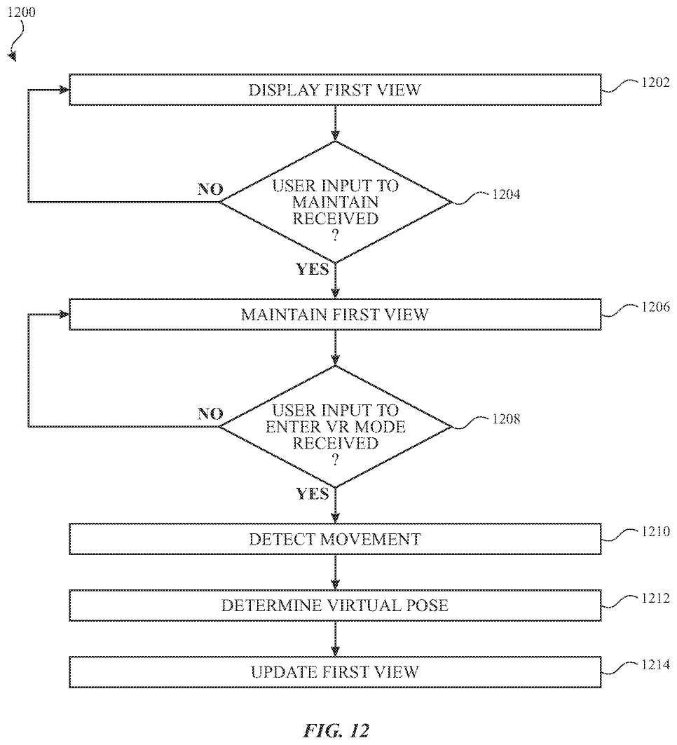

Below, FIGS. 1, 2, and 3A-B provide a description of exemplary systems and devices for providing accessible mixed reality applications. FIGS. 4A-K, 5A-C, 6A-F, 7A-C, 8A-B, and 9A-C illustrate example techniques for providing accessible mixed reality applications. FIGS. 4A-K and 5A-C are used to illustrate the processes described below, including the process of FIG. 10. FIGS. 6A-F, 7A-C, and 8A-B are similarly used to illustrate the processes described below, including the process of FIG. 11. FIGS. 9A-C are similarly used to illustrate the processes described below, including the process of FIG. 12.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### 1. Electronic Devices for Providing Accessibility Features

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads) or head mounted devices, are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

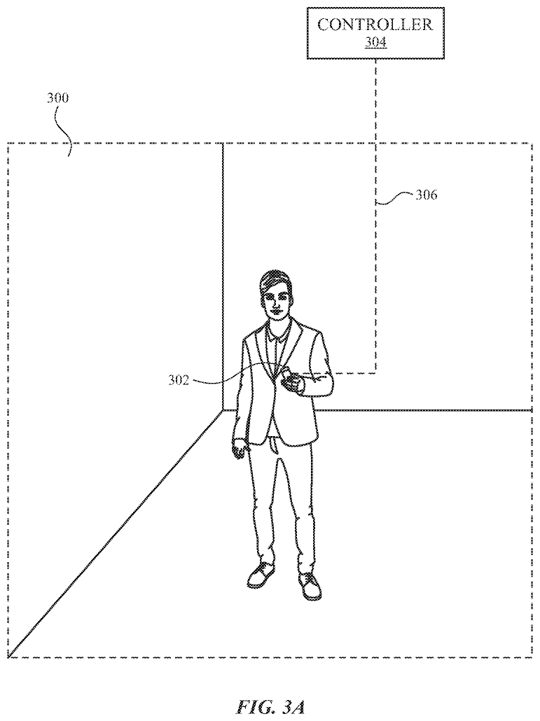

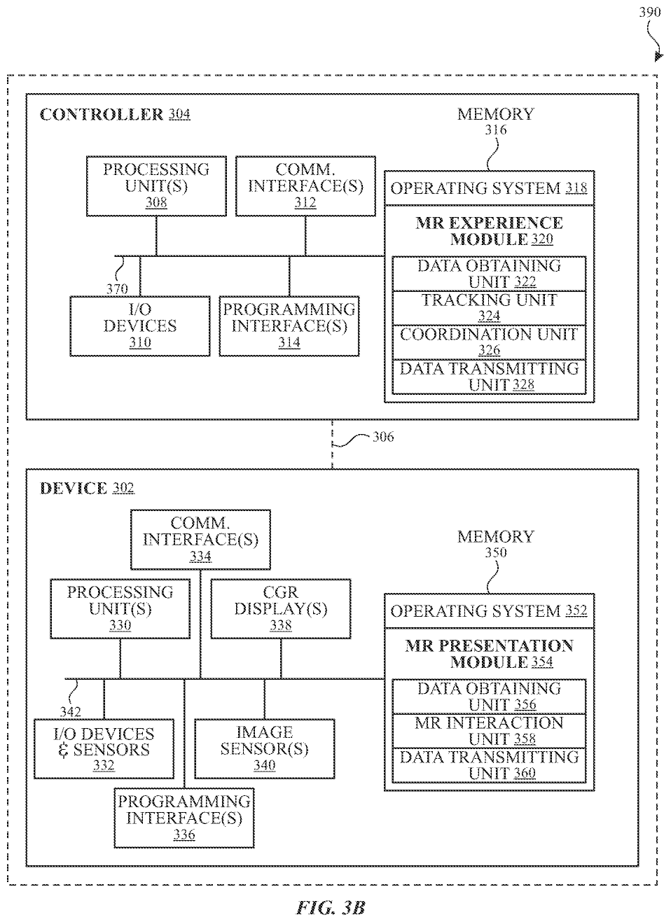

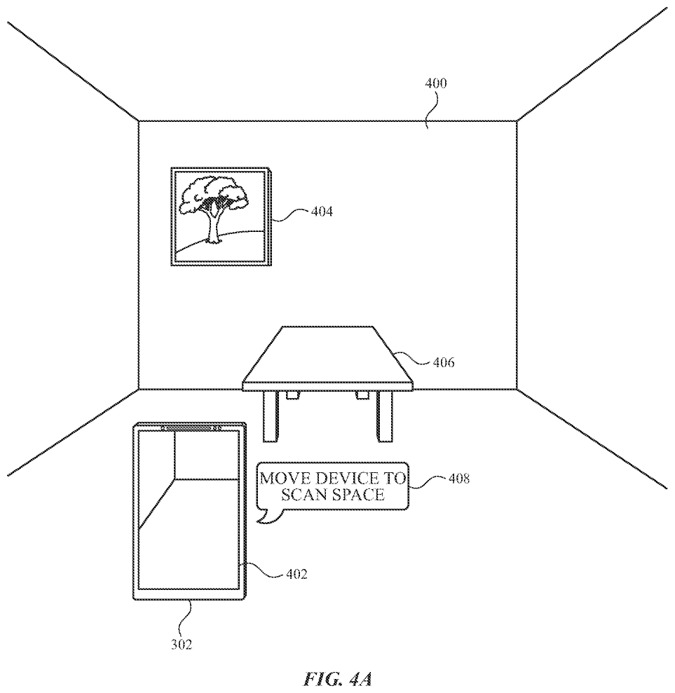

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application. Any of these applications may be configured to provide a mixed reality experience, as discussed with respect to FIGS. 3A-B below.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of devices with touch-sensitive displays. FIG. 1A is a block diagram illustrating multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

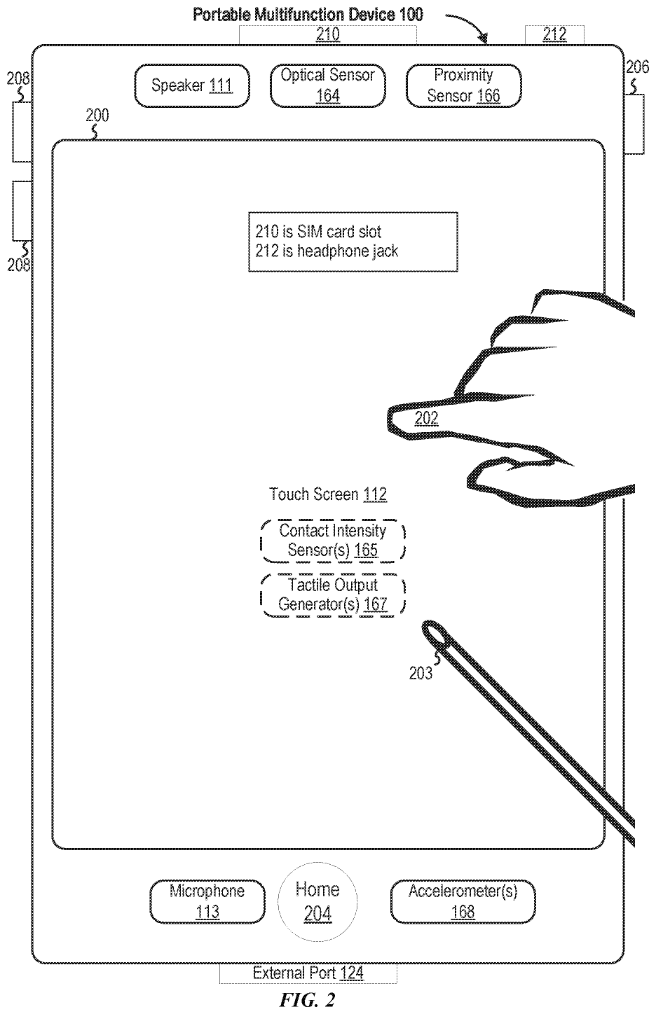

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, accessibility module 131, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Accessibility module 131, in conjunction with other components and modules of device 100 (e.g., audio circuitry 110, speaker 111, touch-sensitive display system 112, display controller 156, contact module 130, graphics module 132, tactile output generator 167) facilitates touch-based navigation among graphical user interface elements so that a user may navigate, select, activate, and otherwise interact with graphical elements in the user interface without necessarily seeing the user interface. In some embodiments, accessibility module 131 facilitates selecting and activating graphical user interface elements within the user interface without directly selecting or contacting those graphical user interface elements. For example, accessibility module 131 includes screen reading software (e.g., VoiceOver by Apple Inc.) and/or software enabling selection and activation of graphical user interface elements using switches (e.g., Switch Control by Apple Inc.).

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 2 illustrates a multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

### 2. Systems and Devices for Providing Mixed Reality

A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands).

A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

An example of CGR is mixed reality. A mixed reality (MR) environment refers to a simulated environment that is designed to incorporate sensory inputs from the physical environment, or a representation thereof, in addition to including computer-generated sensory inputs (e.g., virtual objects).

In some MR environments, computer-generated sensory inputs may respond to changes in sensory inputs from the physical environment. Also, some electronic systems for presenting a MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed reality include augmented reality and augmented virtuality.

An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system (e.g., device 100) may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment.

An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

There are many different types of electronic systems that enable a person to sense and/or interact with various CGR environments. These electronic systems may include at least a portion of the components discussed with respect to FIGS. 1 and 2. Such electronic systems include, for example, head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

FIGS. 3A-B illustrate systems and environments for providing accessible MR applications, according to some embodiments. FIG. 3A illustrates a MR experience provided using device 302, and optionally, controller 304, to a user in a physical environment 300.

Controller 304 is configured to manage and coordinate a MR experience for the user. Controller 304 includes a suitable combination of software, firmware, and/or hardware to manage and coordinate the MR experience, as discussed in greater detail below with respect to FIG. 3B. In some embodiments, controller 304 is a computing device that is local or remote relative to environment 300. For example, controller 304 is a local server located within environment 300 (e.g., the room where the user is located). As another example, controller 304 is a remote server (e.g., a cloud server, central server) located outside of environment 300. In some embodiments, controller 304 is communicatively coupled to device 302 via one or more wired or wireless communication channels 306 (e.g., BLUETOOTH, IEEE 802.11x, IEEE 802.16x, IEEE 802.3x, etc.). In some embodiments, controller 304 is part of device 302. For example, controller 304 is included in the enclosure of device 302, such that any of the components or functions of controller 304 discussed below are included in or provided by device 302.

Device 302 is configured to provide a MR experience to the user. Device 302 includes a suitable combination of software, firmware, and/or hardware to provide the 1\4R experience, as discussed in greater detail below with respect to FIG. 3B. In some embodiments, the functions of controller 304 are provided by and/or combined with those of device 302. In some embodiments, device 302 is at least partially implemented using device 100, and any components of device 100 (e.g., accessibility module 131) may be included in and/or combined with the components of device 302.

Device 302 provides a MR experience to the user while the user is physically present within environment 300. In some embodiments, while providing a MR experience, device 302 presents MR content (e.g., one or more virtual objects) and enables optical see-through of the environment 300. In some embodiments, while providing a MR experience, device 302 presents MR content overlaid or otherwise combined with images or portions thereof captured by the scene camera of device 302. In some embodiments, while presenting MR content, device 302 presents elements of the real world, or representations thereof, combined with or superimposed over a user's view of a computer-simulated environment.

In some embodiments, as shown in FIG. 3A, device 302 is a handheld device (e.g., a smartphone or a tablet) and a user holds the device such that the device display appears in the user's field of view and the device's camera(s) face environment 300. In some embodiments, the handheld device can be placed within an enclosure that is worn on the user's head. In some embodiments, device 302 is a head mounted device worn on the user's head. As such, device 302 includes one or more displays for displaying MR content and may enclose the user's field of view.

FIG. 3B is a block diagram of system 390 for providing accessible mixed reality applications, according to some embodiments. The various components of system 390 are implemented using hardware, software, or a combination of hardware and software to carry out the principles discussed herein. Further, system 390 is exemplary, and thus system 390 can have more or fewer components than shown, can combine two or more components, or can have a different configuration or arrangement of the components. Further, although the below discussion describes functions being performed at a single component of system 390, it is to be understood that such functions can be performed at other components of system 390 and that such functions can be performed at more than one component of system 390.

System 390 includes controller 304 and device 302.

In some embodiments, controller 304 includes one or more processing units 308 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 310, one or more communication interfaces 312 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like), one or more programming (e.g., I/O) interfaces 314, a memory 316, and one or more communication buses 370 for interconnecting these and various other components.

In some embodiments, one or more communication buses 370 include circuitry that interconnects and controls communications between system components. In some embodiments, one or more I/O devices 310 include at least one of a keyboard, a mouse, a touchpad, a joystick, one or more microphones, one or more speakers, one or more image sensors, one or more displays (e.g., touch sensitive displays), and/or the like.

Memory 316 includes high-speed random-access memory, such as dynamic random-access memory (DRAM), static random-access memory (SRAM), double-data-rate random-access memory (DDR RAM), or other random-access solid-state memory devices. In some embodiments, memory 316 includes non-volatile memory, such as one or more magnetic disk storage devices, optical disk storage devices, flash memory devices, or other non-volatile solid-state storage devices. Memory 316 optionally includes one or more storage devices remotely located from one or more processing units 308. Memory 316 includes a non-transitory computer readable storage medium. In some embodiments, memory 316 or the non-transitory computer readable storage medium of memory 316 stores the following programs, modules and data structures, or a subset thereof including an optional operating system 318 and a MR experience module 320.

Operating system 318 includes procedures for handling various basic system services and for performing hardware dependent tasks. In some embodiments, MR experience module 320 is configured to manage and coordinate a MR experience for one or more users. In various embodiments, MR experience module 320 includes data obtaining unit 322, tracking unit 324, coordination unit 326, and data transmitting unit 328.

In some embodiments, data obtaining unit 322 is configured to obtain data (e.g., presentation data, interaction data, sensor data, pose data) from at least device 302. Thus, in some embodiments, data obtaining unit 322 includes computer executable instructions and/or logic therefor.

In some embodiments, tracking unit 324 is configured to track the pose (e.g., location and orientation) of device 302 with respect to the environment 300 (e.g., with respect to other physical or virtual objects in environment 300). Thus, in some embodiments, tracking unit 324 includes computer executable instructions and/or logic therefor.

In some embodiments, coordination unit 326 is configured to manage and coordinate the MR experience provided by device 302. Thus, in some embodiments, coordination unit 326 includes computer executable instructions and/or logic therefor. For example, using data provided by data obtaining unit 322 and tracking unit 324, coordination unit 326 determines various information associated with a user's MR environment, e.g., using techniques known in computer vision and/or CGR. As one example, coordination unit 326 determines when an object (e.g., physical object, virtual object) appears in a field of view of one or more camera(s) of device 302 and/or determines the identity of the object. As another example, coordination unit 326 determines a distance between an object and device 302 and/or directions from device 302's current location to the object. As yet another example, coordination unit 326 detects predetermined features (e.g., vertical or horizontal planes, predetermined types of objects) in the field of view of device 302's cameras and/or determines characteristics of the features (e.g., area, length, height). As yet another example, based on detected movement of device 302 (e.g., between poses), coordination unit 326 determines updated views of a MR environment for display on device 302.

In some embodiments, data transmitting unit 328 is configured to transmit data (e.g., presentation data, pose data) to at least device 302. Thus, in some embodiments, data transmitting unit 328 includes computer executable instructions and/or logic therefor. For example, data transmitting unit 328 transmits data representing information associated with a user's MR environment (determined by coordination unit 326) to device 302 for presentation.

In some embodiments, device 302 includes one or more processing units 330 (e.g., microprocessors, ASICs, FPGAs, GPUs, CPUs, processing cores, and/or the like), one or more input/output (I/O) devices and sensors 332, one or more communication interfaces 334 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like), one or more programming (e.g., I/O) interfaces 336, one or more CGR displays 338, one or more interior and/or exterior facing image sensors 340, a memory 350, and one or more communication buses 342 for interconnecting these and various other components.

In some embodiments, one or more communication buses 342 include circuitry that interconnects and controls communications between system components. In some embodiments, one or more I/O devices and sensors 332 include at least one of an inertial measurement unit (IMU), an accelerometer, a gyroscope, a thermometer, one or more physiological sensors (e.g., blood pressure monitor, heart rate monitor, blood oxygen sensor, blood glucose sensor), one or more microphones, one or more speakers, a haptics engine, one or more depth sensors (e.g., a structured light, a time-of-flight, or the like), and/or the like.

In some embodiments, one or more CGR displays 338 are configured to provide the CGR experience to the user. In embodiments, one or more CGR displays 338 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some embodiments, one or more CGR displays 338 correspond to diffractive, reflective, polarized, holographic, etc. waveguide displays. For example, device 302 includes a single CGR display, such as touchscreen. As another example, device 302 includes a CGR display for each eye of the user.

In some embodiments, one or more image sensors 340 are configured to obtain image data that corresponds to at least a portion of the face of the user that includes the eyes of the user. For example, one or more image sensors 340 include one or more eye-tracking cameras. In some embodiments, one or more image sensors 340 are configured to be forward-facing to obtain image data that corresponds to the environment (or portion thereof) as would be viewed by the user if device 340 was not present. In some embodiments, one or more image sensors 340 include one or more RGB cameras (e.g., with a complimentary metal-oxide semiconductor (CMOS) image sensor or a charge-coupled device (CCD) image sensor), one or more infrared (IR) cameras, one or more event-based cameras, and/or the like.

Memory 350 includes high-speed random-access memory, such as DRAM, SRAM, DDR RAM, or other random-access solid-state memory devices. In some embodiments, memory 350 includes non-volatile memory, such as one or more magnetic disk storage devices, optical disk storage devices, flash memory devices, or other non-volatile solid-state storage devices. Memory 350 optionally includes one or more storage devices remotely located from one or more processing units 330. Memory 350 includes a non-transitory computer readable storage medium. In some embodiments, memory 350 or the non-transitory computer readable storage medium of memory 350 stores the following programs, modules and data structures, or a subset thereof including optional operating system 352 and MR presentation module 354.

Operating system 352 includes procedures for handling various basic system services and for performing hardware dependent tasks. In some embodiments, MR presentation module 354 is configured to present MR content to the user via one or more CGR displays 338 and/or one or more I/O devices and sensors 332. In various embodiments, MR presentation module 354 includes data obtaining unit 356, MR interaction unit 358, and data transmitting unit 360.

In some embodiments, data obtaining unit 356 is configured to obtain data (e.g., presentation data, interaction data, sensor data, pose data, etc.) from at least controller 304. Thus, in some embodiments, data obtaining unit 356 includes computer executable instructions and/or logic therefor. For example, data obtaining unit 356 obtains data representing various information associated with a MR environment determined by coordination unit 326.

In some embodiments, MR interaction unit 358 is configured to present MR content and allow a user to interact with MR content via the one or more CGR displays 338 and/or I/O devices and sensors 332. Thus, in some embodiments, MR interaction unit 358 includes computer executable instructions and/or logic therefor. For example, MR interaction unit 358 uses data obtained by data obtaining unit 356 to present graphical, audio, and/or haptic output associated with a MR environment.

In some embodiments, as discussed below with respect to FIGS. 4A-K, 5A-C, 6A-F, 7A-C, 8A-B, and 9A-C, MR interaction unit 358 presents MR content and allows users to interact with such content in an accessible manner. As such, in some embodiments, MR interaction unit 358 includes accessibility module 131. The inclusion of accessibility module 131 may allow users to interact with MR content without necessarily seeing a user interface presenting MR content (e.g., MR content provided by CGR display(s) 338) and/or without necessarily directly contacting the user interface. As one example, MR interaction unit 358 provides audible information to facilitate user input at device 302 (e.g., touch input, speech input, user movement, device movement) to select, modify, or otherwise interact with MR content. As another example, MR interaction unit 358 facilitates interaction with MR content without requiring the user to directly contact device 302, e.g., by enabling user selection of user interface elements without direct device contact.

In some embodiments, data transmitting unit 360 is configured to transmit data (e.g., presentation data, pose data, etc.) to at least controller 304. Thus, in some embodiments, data transmitting unit 360 includes computer executable instructions and/or logic therefor.

### 3. Techniques for Accessible Mixed Reality

FIGS. 4A-K, 5A-C, 6A-F, 7A-C, 8A-B, and 9A-C illustrate techniques for providing accessible mixed reality, according to some embodiments. In some embodiments, the techniques discussed below are implemented using system 390. For example, MR interaction unit 358, using information determined by coordination unit 326, provides an accessible MR experience by enabling user input and by providing graphical, audio, and/or haptic output according to detected user inputs. However, one of skill in the art will recognize that various other components of system 390 may additionally or alternatively be employed to implement the techniques discussed below. Further, while the below description of FIGS. 4A-K, 5A-C, 6A-F, 7A-C, 8A-B, and 9A-C describes device 302 as implementing various techniques, it is to be understood that such techniques may be implemented by other components of system 390, or by using device 302 in conjunction with other components of system 390.

Further, the present disclosure recognizes that accessibility features for a satisfactory user MR experience may vary depending on the purposes/features of particular MR software applications. However, there are exemplary common user interactions that may be desirable for many MR software applications. Such interactions include scanning the environment around a user (e.g., to capture a representation of the physical environment to be augmented with virtual elements), placing virtual objects in a MR environment, and exploring a MR environment (e.g., locating virtual objects in a MR environment and interacting with different views of a MR environment). Improving the accessibility of such common MR interactions may be desirable.

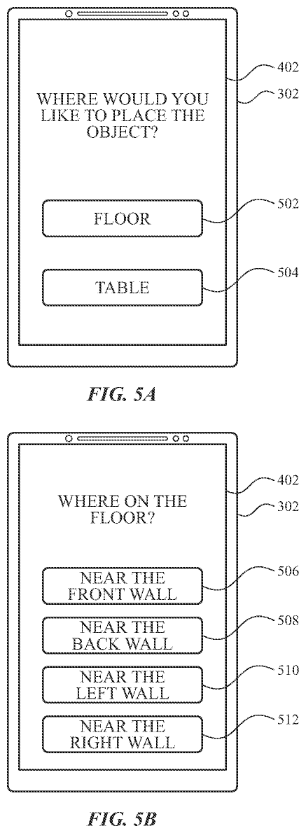

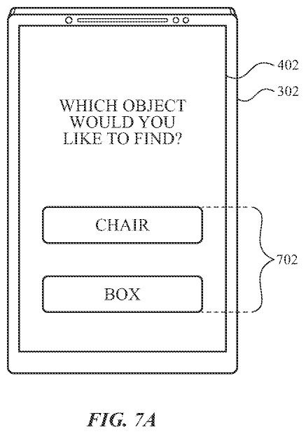

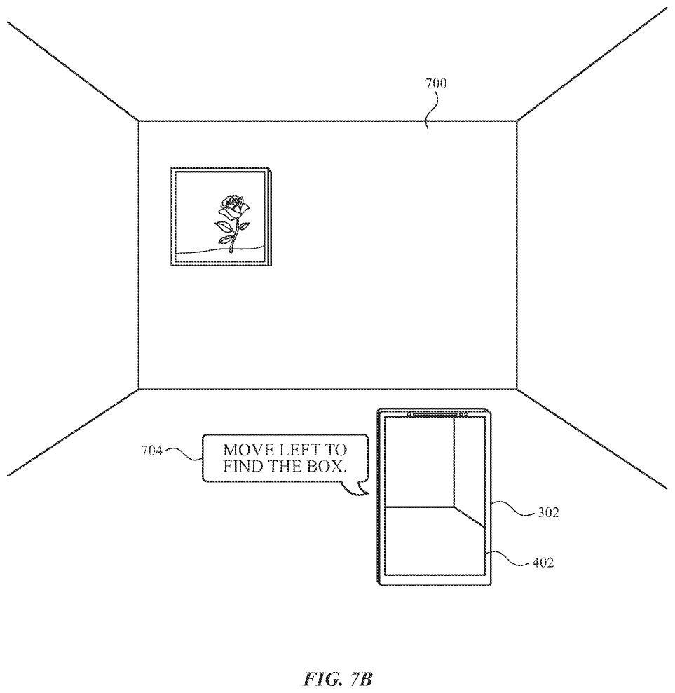

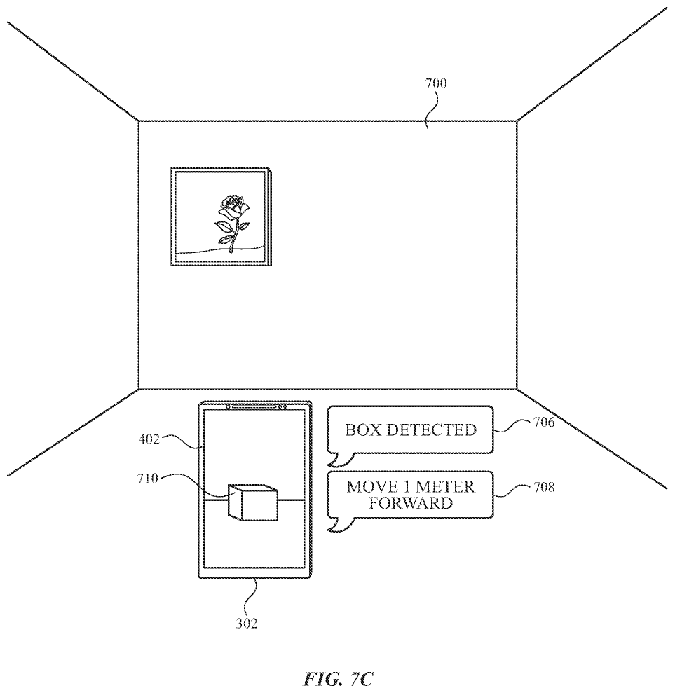

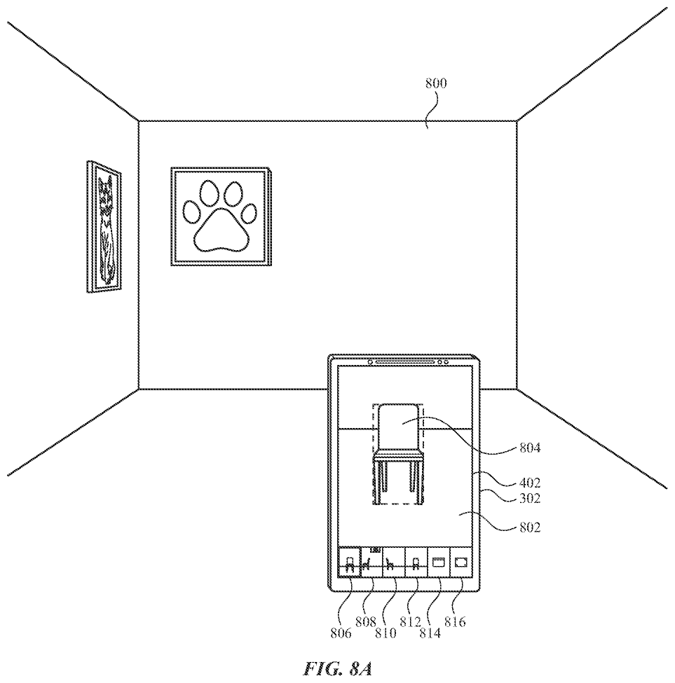

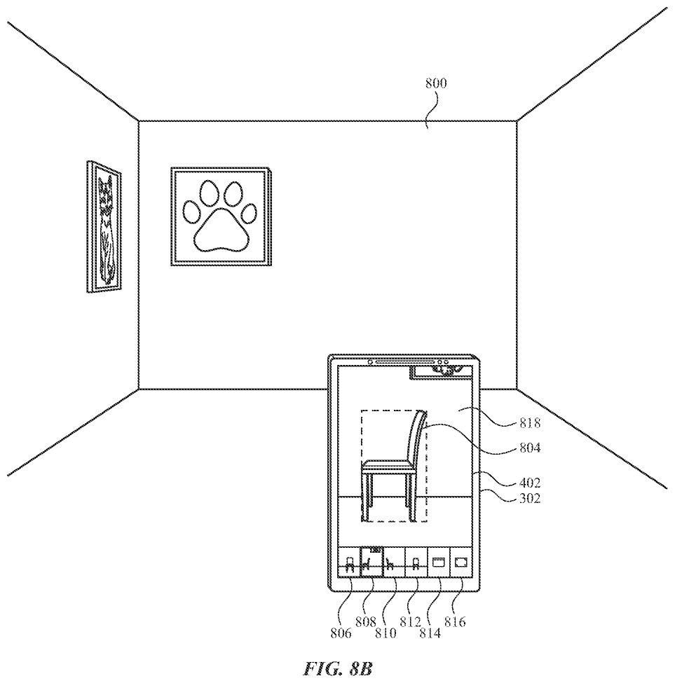

As such, FIGS. 4A-D illustrate accessible techniques for scanning a MR environment, according to some embodiments. FIGS. 4E-K illustrate accessible techniques for placing virtual objects in a MR environment, according to some embodiments. FIGS. 5A-C illustrate further accessible techniques for placing virtual objects in a MR environment, according to some embodiments. FIGS. 6A-F illustrate accessible techniques for locating virtual objects in a MR environment, according to some embodiments. FIGS. 7A-C illustrate further accessible techniques for locating virtual objects in a MR environment, according to some embodiments. FIGS. 8A-B illustrate accessible techniques for exploring a MR environment, according to some embodiments. FIGS. 9A-C illustrate accessible techniques for maintaining and updating a view of a MR environment, according to some embodiments.

In FIGS. 4A-K, 5A-C, 6A-F, 7A-C, 8A-B, and 9A-C device 302 may be held by a user or worn on the user's head. For example, device 302 is a smartphone, tablet, or head mounted device (HMD). Display 402 of device 302 (e.g., implemented as CGR display(s) 338) depicts the CGR content viewed by the user. The user is not illustrated for simplicity and to avoid obscuring pertinent elements of the drawings.

FIG. 4A illustrates device 302 providing audio output 408 instructing a user to move device 302 to scan environment 400, according to some embodiments. In some embodiments, environment 400 is a physical environment.

Environment 400 includes a plurality of features, e.g., physical or virtual articles. For example, environment 400 includes physical painting 404 and physical table 406. In some embodiments, device 302 scans environment 400 to detect predetermined types of features. Example predetermined types of features include vertical planes, horizontal planes, and particular objects, e.g., barcodes, furniture, musical instruments, human or animal faces, etc.

In some embodiments, audio output 408 provides a user with the requirements for scan completion. In some embodiments, audio output 408 indicates a number of features to be scanned and/or an area to be scanned. The number of features to be scanned and/or the area to be scanned may vary depending on the requirements of a particular application. For example, a MR application allowing placement of virtual objects in a physical environment may require detection of a predetermined number of planes having a predetermined area. As a particular example, audio output 408 additionally includes “your goal is to scan at least three planes” and/or “the three planes must total at least 40 square feet.” In some embodiments, audio output 408 includes directions for moving device 302, e.g., “move left,” “turn left,” “move up,” and the like.

FIG. 4B illustrates that the user has moved device 302 relative to FIG. 4A according to audio output 408. While device 302 detects its movement, device 302 scans environment 400 with one or more sensors (e.g., one or more cameras included in image sensor(s) 340) to detect features (e.g., predetermined types of features) using the scan data. In some embodiments, responsive to detecting a feature, device 302 provides audio output 410 indicating the detection of the feature. In some embodiments, audio output 410 indicates an identity of the detected feature and/or a measurement (e.g., length, width, area) associated with the detected feature. In some embodiments, audio output 410 indicates additional information associated with the detected feature, such as a distance between the feature and device 302, a position of the detected feature relative to a previously detected feature, and the like.

For example, in FIG. 4B, device 302 has moved so the top surface of table 406 appears in device 302's field of view, e.g., the field of view of the device camera(s). Device 302 detects the horizontal plane corresponding to the top of the table and provides audio output 410 “new horizontal plane detected.”

In some embodiments, device 302 displays a visual element adjacent to each detected feature. In some embodiments, the visual element includes a grid, mesh, animation, icon, or other visual element to indicate the detection of a feature. For example, in FIG. 4B, device 302 displays grid 412 over the detected horizontal plane corresponding to table 406.

In some embodiments, device 302 determines that a feature (e.g., predetermined type of feature) has not been detected for a predetermined duration, e.g., a predetermined duration since detecting a previous feature of a predetermined type. In some embodiments, in accordance with determining that the feature has not been detected for a predetermined duration, device 302 provides audio output 414 instructing a user to move device 302. In some embodiments, audio output 414 includes instructions for moving device 302 to detect the feature, e.g., “please move left to keep scanning.”

For example, in FIG. 4B, after device 302 detects the horizontal plane, device 302 determines that no plane has been detected for a predetermined duration (e.g., 5 seconds). For example, the user may have remained relatively still after detection of the horizontal plane. Device 302 thus provides audio output 414 “please keep moving the device.”

FIG. 4C illustrates that the user has moved device 302 relative to FIG. 4B according to audio output 414. Device 302 continues to scan environment 400 to detect features. For example, device 302 detects the horizontal plane corresponding to the floor of environment 400 and provides audio output 416 indicating the detection, e.g., “new horizontal plane detected.”

In some embodiments, while scanning environment 400, device 302 provides audio output 418 indicating a progress of the scanning. In some embodiments, audio output 418 indicates an amount of environment 400 scanned relative to the amount required to be scanned. For example, audio output 418 indicates a number of detected features of a predetermined type and/or a total area associated with the detected features. As another example, audio output 418 indicates a percentage or fraction of the environment scanned, e.g., “65% complete.” In FIG. 4C, audio output 418 includes “detected two planes, total area 35 square feet.” In some embodiments, device 302 periodically provides audio output 418, e.g., provides audio output 418 once every predetermined duration and/or upon detection of a new feature.

FIG. 4D illustrates that the user has moved device 302 relative to FIG. 4C. Device 302 continues to scan environment 400 to detect features. For example, device 302 detects the vertical plane corresponding to the back wall of environment 400 and provides audio output 420 indicating the detection, e.g., “new vertical plane detected.” Device 302 further provides audio output 422 indicating a progress of the scanning, e.g., “detected 3 planes, total area 75 square feet.”

In some embodiments, device 302 determines that scanning of environment 400 is complete. In some embodiments, determining that scanning of environment 400 is complete includes determining that a predetermined number of features of a particular type have been detected and/or determining that a total area scanned (e.g., total area associated with the detected features) exceeds a threshold area. In some embodiments, in accordance with determining that scanning of environment 400 is complete, device 302 provides audio output 424 indicating a completion of the scanning, e.g., “scanning complete.”

Providing the audio outputs described above (e.g., 408, 410, 414, 416, 418, 420, 422, or 424, or a combination or sub-combination thereof) may improve the accessibility of MR software applications involving scanning a user's environment. For example, the audio outputs may audibly indicate scan progress and/or instruct device movements when scanning an environment. Such outputs may be particularly beneficial for visually impaired users, as sighted users may visually confirm when features are detected and the scan progress (e.g., through display of grids on detected planes) and know when to move the device for scan completion (e.g., based on their view of the environment).

FIGS. 4E-K illustrate accessible techniques for placing virtual objects in a MR environment, according to some embodiments.

In some embodiments, any of the techniques discussed below with respect to FIGS. 4E-K, 5A-C, 6A-F, 7A-C, 8A-B, and 9A-C are performed after completion of scanning of an environment. For example, a MR application may require users to scan a physical environment prior to allowing users to place virtual objects within the environment. In other embodiments, any of the techniques discussed below with respect to FIGS. 4E-K, 5A-C, 6A-F, 7A-C, 8A-B, and 9A-C are performed before scanning an environment, or independently of (e.g., without) scanning an environment. For example, a MR application may allow placement of virtual objects in a physical environment without scanning the environment.

FIG. 4E illustrates view 426 of environment 400 viewed on display 402. In some embodiments, device 302 provides view 426 from a perspective corresponding to the current location of device 302. For example, view 426 corresponds to the field of view of device 302's camera(s) at the current location. As another example, view 426 corresponds to the user's field of view at the current location, e.g., if device 302 includes a transparent or translucent display through which the user may directly view environment 400.

View 426 includes virtual object 428 (e.g., a houseplant) displayed at a location on a surface of environment 400. In some embodiments, the surface is a bottom surface of environment 400, such as the floor or ground. In other embodiments, object 428 is displayed on another surface of environment 400, such the top surface or a surface corresponding to an object.

In some embodiments, the location at which object 428 is displayed corresponds to the location (e.g., physical location) of device 302. For example, when device 302 is directly above a surface (e.g., no other intervening surfaces between the device and the surface), object 428 is located on the surface at a location defined by the perpendicular projection of device 302's location onto the surface. In other words, assuming a x y plane defines the surface and the z coordinate defines device 302's position above or below the surface, if device 302 has a location of (x, y, z), then object 428 has a location of (x, y, 0). As another example, the location of object 428 on the surface is such that the bottom of display 402 displays an edge (e.g., back edge) of object 428, e.g., as shown in FIG. 4E. In this manner, a virtual object for placement appears to be displayed directly in front of a user's feet as the user moves about. Thus, a virtual object's location “follows” device 302's location (and thus the user's physical location) as the user moves about, as shown in FIG. 4F.

FIG. 4F illustrates view 426 viewed on display 402 in accordance with detecting device movement. In particular, device 302 has moved forward from its location in FIG. 4E to its updated location in FIG. 4F. View 426 now includes object 428 displayed at a location on the bottom surface of environment 400, the location corresponding to the updated location of device 302.

In some embodiments, device 302 determines that object 428 cannot be placed at a particular location where object 428 is displayed. In some embodiments, determining that object 428 cannot be placed at the particular location includes determining that the extent of object 428, when placed at the particular location, overlaps with an extent of another physical or virtual object in environment 400, e.g., a wall, ceiling, or table. For example, device 302 determines that a bounding box of object 428 (e.g., a box around object 428 having the maximum length, maximum width, and maximum height of object 428) overlaps with the bounding box (or bounding plane, for two dimensional objects) of another object. In some embodiments, determining that object 428 cannot be placed at a particular location includes determining that object 428, if placed at the particular location, is within a threshold distance of another object, e.g., a wall.

FIG. 4G illustrates view 426 viewed on display 402 in accordance with detecting device movement, e.g., movement closer to table 406 relative to FIG. 4F. Device 302 determines that object 428 cannot be placed at the particular location where it is displayed. For example, device 302 determines that object 428 is too close to table 406.

In some embodiments, in response to determining that object 428 cannot be placed at a particular location, device 302 provides audio output 430 indicating that object 428 cannot be placed at the particular location, e.g., “object does not fit here.” In some embodiments, in response to determining that object 428 cannot be placed at a particular location, device 302 disables user input to place object 428 until object 428 is displayed at a location where placement is permitted. In some embodiments, in response to determining that object 428 cannot be placed at a particular location, device 302 additionally provides a haptic output such as a vibration or buzz.

Turning to FIG. 4H, in some embodiments, device 302 detects that it is moved above a second surface in environment 400. In some embodiments, the second surface (e.g., the top surface of table 406) is above a first surface (e.g., the ground or floor) of environment 400. For example, device 302 detects that it is above the surface of table 406 by detecting the plane corresponding to table 406 directly below device 302.

In some embodiments, in accordance with detecting device movement to be above the second surface, device 302 displays object 428 at a location on the second surface. The location of object 428 on the second surface corresponds to the location of device 302 above the second surface, e.g., as discussed above with respect to FIGS. 4E-F. Although FIG. 4H shows that device 302 is located on the second surface (e.g., table 406), device 302 need not be physically on the second surface for object 428 to be displayed on the second surface. Rather, device 302 being anywhere directly above the second surface may cause object 428 to be displayed on the second surface. In some embodiments, in accordance with detecting device movement to be above the second surface, device 302 provides audio output 432 indicating that object 428 has changed surfaces. In some embodiments, audio output 432 indicates an identity of the object (or surface) object 428 is currently on and/or the identity of the object (or surface) object 428 was previously on.

For example, FIG. 4H illustrates that device 302 has moved above table 406. View 426 includes object 428 displayed on table 406. Device 302 additionally provides audio output 432 “object now on table.”

In some embodiments, device 302 detects that it is moved while it is above a second surface. In some embodiments, while detecting movement of device 302 above the second surface, device 302 updates view 426 to display object 428 at a plurality of locations on the second surface, the plurality of locations corresponding to the movement of device 302 above the second surface. Thus, in some embodiments, while device 302 is moved above a second surface, object 428 continues to “follow” the device's location while being constrained to the second surface.

For example, FIG. 4I illustrates movement of device 302 above table 406. While device 302 moves above table 406, device 302 updates view 426 to display object 428 at locations corresponding to device 302's movement. For example, because device 302 has moved left above table 406 (relative to FIG. 4H,) device 302 provides view 426 including object 428 displayed on the left side of table 406.

Turning to FIG. 4J, in some embodiments, device 302 detects that it is no longer above the second surface. For example, device 302 determines based on its movement, that it is now below the second surface and/or moved away from the second surface. For example, in FIG. 4J, device 302 has moved backward such that it is no longer above table 406, and is instead above the floor.

In some embodiments, in accordance with detecting that device 302 is no longer above the second surface, device 302 updates view 426 to display object 428 on a surface (e.g., the floor) device 302 is now directly above. In some embodiments, the location of object 428 on the surface corresponds to the location of device 302 such that object 428 continues to “follow” device 302. For example, in FIG. 4J, object 428 is now displayed on the floor next to table 406.

In some embodiments, in accordance with detecting that device 302 is no longer above the second surface, device 302 provides audio output 434 indicating that object 428 has changed surfaces. In some embodiments, similar to audio output 432, audio output 434 indicates an identity of the object (or surface) object 428 is currently on and/or the identity of the object (or surface) object 428 was previously on. For example, audio output 434 includes “object now on floor.”

In some embodiments, device 302 receives user input to place object 428. In some embodiments, the user input corresponds to a user selection (e.g., touch gesture) of a displayed user interface element on device 302 or a user input received via an external device (e.g., a mouse or keyboard). In some embodiments, the user input corresponds to speech input, e.g., “place the object here.”

In some embodiments, in response to receiving user input to place object 428, device 302 places object 428 at a location where it is displayed, e.g., displayed when the user input was received. For example, in FIG. 4J, device 302 places object 428 on the floor next to table 406.

In some embodiments, placing object 428 includes providing audio output 436 indicating the placement of object 428. In some embodiments, audio output 436 indicates an identity of placed object 428 and/or a location of object placement, e.g., relative to a location of another object. For example, audio output 436 includes a distance between object 428's placement location and another object and/or an orientation of object 428's placement location relative to another object (e.g., in front of, behind, to the side, above, or below). In FIG. 4J, audio output 436 includes “placed object 2 feet from table.”

In some embodiments, after placing object 428, device 302 moves from its previous location (corresponding to where object 428 was placed) to an updated location. FIG. 4K illustrates movement of device 302 after object 428 is placed. In some embodiments, in accordance with detecting movement from the previous location to the updated location, device 302 updates view 426. Updated view 426 includes object 428 displayed at the location where it was placed. Notably, as shown in FIG. 4K, the location of object 428 no longer corresponds to the location of device 302. In this manner, after placing a virtual object, the virtual object no longer “follows” the device.

The techniques discussed above with respect to FIGS. 4A-K may improve the accessibility of MR software applications involving placing virtual objects. For example, sighted users may place virtual objects by simply pointing a device camera to a location where placement is desired and selecting a location in the displayed view (e.g., via a touchscreen) to place the virtual object. Similarly, sighted users may visually confirm when virtual objects do not fit at particular locations. Such approaches for placing virtual objects and confirming that virtual objects do not fit may be impracticable for visually impaired users. The techniques discussed above may thus improve accessibility by having the virtual object's location correspond to the device's physical location (thereby increasing awareness of a virtual object's current location) and/or by providing audible notifications when a virtual object does not fit at a particular location.

FIGS. 5A-C illustrate further accessible techniques for placing virtual objects.

Generally, FIGS. 5A-C illustrate techniques for placing virtual objects using one or more questions device 302 presents the user. In some embodiments, the one or more questions are sequential, such that a next question (and permitted responses to the next question) depend on a user response to a previous question. In some embodiments, the techniques discussed below with respect to FIGS. 5A-C allow placement of virtual objects with limited or no user movement about their environment, and thus may benefit users with limited mobility.

FIG. 5A illustrates device 302 providing a question to a user regarding where to place a virtual object and providing selectable responses 502 and 504. In some embodiments, the questions and/or selectable responses 502 and 504 are visually provided (e.g., displayed) and/or audibly provided. In some embodiments, the question and/or selectable responses 502 and 504 depend on the environment where device 302 is located. For example, device 302 determines (e.g., through scanning or other means) information associated with the environment, and determines based on such information, locations where object placement is permitted, e.g., locations on horizontal surfaces. Device 302 thus provides selectable responses 502 and 504 corresponding to the permitted locations.

For example, device 302 determines that within environment 400 (as shown in FIG. 4A), object placement is permitted on table 406 and on the floor. Device 302 thus provides selectable responses “floor” 502 and “table” 504. In the illustrated example, the user selects “floor” 502, e.g., via a touch gesture. In some embodiments, selection of selectable responses 502 or 504 is facilitated by accessibility software such as VoiceOver or Switch Control by Apple Inc. In some embodiments, a user selects selectable response 502 or 504 by providing audio input, e.g., by saying “on the floor.”

FIG. 5B illustrates device 302 providing a following question regarding where to place the virtual object based on the user selection in FIG. 5A. Device 302 further presents selectable responses 506, 508, 510, and 512. In some embodiments, selectable responses 506-512 provide more detailed options for placing the virtual object, e.g., based on the user's response to a previous question. For example, after the user responds to the previous question by selecting an object on which placement is desired, selectable responses 506-512 respectively correspond to various locations on the selected object. In some embodiments, the various locations correspond to locations near the edges of the selected object and near the center of the selected object. As a specific example, selectable responses 506-512 respectively correspond to different locations on the floor of environment 400.

In some embodiments, after user selection of one of responses 506-512, device 302 determines a location at which to place the virtual object based on the user selection. For example, if the user selects “near the front wall” 506, device 302 determines a location near the front wall of environment 400 to place the object. In some embodiments, the determined location is such that the extent of the object, when placed at the determined location, does not overlap with the extent of another object within environment 400. In some embodiments, the determined location is not within a predetermined distance of any other object within environment 400.

In some embodiments, device 302 determines an orientation with which to place the virtual object at the determined location. In some embodiments, the orientation is predetermined, e.g., such that a particular face of the object (e.g., front face) faces the user and/or electronic device 302. In other embodiments, device 302 requests (e.g., visually or audibly) for user input to determine the orientation with which to place the object and provides the user with selectable orientations. In some embodiments, the selectable orientations are relative to device 302, or relative to another object within environment 400. For example, device 302 outputs “how would you like the object to be oriented?” and provides selectable options: (1) “front side facing you,” (2) “left side facing you,” (3) “right side facing you,” and (4) “back side facing you.” A user may then select one of these options to cause placement of the object with the selected orientation, e.g., similar to the user selection of options 506-512.

FIG. 5C illustrates device 302 in environment 400 after the user selects a response in FIG. 5B. Device 302 provides view 426 on display 402, including virtual object 428 placed at the user's selected location, e.g., near the front wall of environment 400. For example, device 302 automatically (e.g., without further user input) places object 428 with a predetermined orientation responsive to the user selection in FIG. 5B. In some embodiments, device 302 provides an audio output indicating the placement of object 428, e.g., similar to audio output 436 discussed above. Notably, in contrast to the techniques discussed above with respect to FIGS. 4A-K, the user is not be required to be physically at (or near) the placement location to place object 428.

In some embodiments, device 302 requires further user input to place virtual object 428 after the user selection in FIG. 5B. For example, device 302 prompts (e.g., visually and/or audibly) the user to move device 302 such that the user and/or device 302 face the determined placement location. For example, device 302 provides audio output 514 instructing the user to move device 302 such that device 302's field of view includes the determined placement location. After device 302 determines that its field of view includes the placement location, device 302 automatically places object 428 at the placement location and/or enables user input to place object 428 at the placement location.

For example, in FIG. 5C, device 302 provides audio output 514 “please face the front wall.” After the user moves device 302 to face the front wall, device 302 places object 428 near the front wall.

Although FIGS. 5A-C illustrate example techniques for placing virtual objects using two sequential questions, any number of sequential questions may be employed to determine the placement location. For example, after the user selects “near the front wall” 506 in FIG. 5B, device 302 may present the question “where near the front wall?” with selectable responses “near the center,” “near the left,” or “near the right.” In this manner, any number of sequential questions may be employed to narrow candidate placement locations to a user's desired location.

FIGS. 6A-F illustrate accessible techniques for locating virtual objects in a MR environment, according to some embodiments.

FIG. 6A illustrates device 302 in environment 600 including physical posters 602 and 604. Device 302 provides a view of environment 600 on display 402.

In some embodiments, device 302 provides audio output 606. Audio output 606 instructs a user to move device 302 such that a virtual object appears in device 302's field of view. In some embodiments, audio output 606 includes instructions for moving device 302 and/or the identity of the virtual object. For example, audio output 606 includes “move right to find the chair.” In some embodiments, device 302 determines the instructions based on the location of device 302 relative to the location of the virtual object (recall that system 390 can track a device's location and determine the locations of objects). In some embodiments, the virtual object is the closest object, of a plurality of virtual objects in environment 600, to device 302. In this manner, device 302 may provide audible instructions guiding a user to face a closest virtual object to be located.

FIG. 6B illustrates that the user has moved device 302 according to audio output 606. Device 302 thus detects virtual object 608. In some embodiments, detecting object 608 includes determining that object 608 appears in device 302's field of view. In FIG. 6B, detected object 608, e.g., a chair, is displayed over a view of physical environment 600.

In some embodiments, in response to detecting object 608, device 302 provides audio output 610. Audio output 610 indicates an identity of object 608 and/or a distance between object 608 and device 302. For example, audio output 610 includes “chair 5 meters away.” In some embodiments, audio output 610 includes directions to object 608, e.g., a direction of object 608 relative to device 302 and/or directions to move device 302 to reach object 608. For example, audio output 610 indicates whether object 608 is directly in front of device 302, to the right side of device 302, or to the left side of device 302. Audio output 610 may thus guide a user to a virtual object to be located.

In some embodiments, in response to detecting object 608, device 302 provides a haptic output, such as a vibration or a buzz. In some embodiments, an intensity of the haptic output is based on a distance between device 302 and object 608, e.g., such that the intensity increases as object 608 gets closer to device 302 and decreases as object 608 gets further from device 302. In some embodiments, the intensity of the haptic output represents a distance between device 302 and the virtual object most recently detected. For example, if device 302 detects a new virtual object after detecting object 608, the intensity of the haptic output represents the distance between device 302 and the new object, not object 608. In some embodiments, device 302 provides the haptic output concurrently with providing an audio output (e.g., audio output 610 or 612). In some embodiments, device 302 continuously provides the haptic output. In some embodiments, device provides the haptic output periodically, e.g., every 5 seconds.

In some embodiments, device 302 determines a data structure (e.g., a scene graph) representing a polyhedron (e.g., a cube) placed around a virtual object. In some embodiments, device 302 determines, based on the data structure, a plurality of two-dimensional representations of the virtual object, where each two-dimensional representation corresponds to a respective face of the polyhedron (or virtual object). For example, based on a scene graph representation of object 608, device 302 computes six two-dimensional representations of object 608 respectively corresponding to the front face, back face, right face, left face, top face, and bottom face of the chair.

In some embodiments, each of the two dimensional representations includes a view of the respective face of the virtual object. For example, in FIG. 6B device 302 displays a view of the front face of chair 608 included in one of the two-dimensional representations of the chair. In some embodiments, each two dimensional representation includes information indicating the respective face of the virtual object and/or additional information associated with the respective face, e.g., the distance between the face and device 302. In some embodiments, the information is capable of audible presentation (e.g., speakable information). For example, each of the plurality of two-dimensional representations of object 608 respectively includes the speakable information “front face of chair,” “back face of chair,” “right face of chair,” “left face of chair,” “top face of chair,” and “bottom face of chair.”

In this manner, device 302 converts a three-dimensional representation of a virtual object (e.g., a scene graph) into a plurality of two-dimensional representations. Converting a three-dimensional representation to a plurality of two-dimensional representations may allow existing accessibility services, such as Apple Inc.'s VoiceOver and Switch Control, to act on (e.g., provide information about and/or facilitate user interaction with) virtual objects. In particular, existing accessibility services may be configured to act on two-dimensional elements (e.g., displayed user-interface elements), and not be natively configured to act on three-dimensional elements such as virtual objects. Thus, having a plurality of two-dimensional representations of a virtual object enables existing accessibility services to act on each face of the virtual object as a two-dimensional element.

For example, using the plurality of two-dimensional representations of a virtual object, an accessibility service enables users to select a particular face of a displayed virtual object. For example, the accessibility service sequentially focuses on (e.g., visually indicates) different faces of the virtual object, and enables user selection (e.g., through a touch gesture or other means) of a currently focused on face. Responsive to the user selection (e.g., a touch on the displayed face), device 302 may provide information associated with the selected face and/or allow user interaction with the selected face. As another example, similar to how an accessibility service audibly reads two-dimensional user interface elements (and optionally visually indicates the user interface element being read), an accessibility service “reads” virtual objects by sequentially providing the speakable information associated with each face of the virtual object and/or by sequentially visually indicating the face of the object being focused on.

Returning to FIG. 6B, in some embodiments, device 302 determines that a particular face of object 608 corresponds to device 302's field of view. In some embodiments, device 302 determines the particular face by identifying the face whose associated orientation most closely matches a direction associated with device 302's one or more cameras. For example, if device 302's field of view includes multiple faces of object 608, the particular face is the face most oriented towards device 302's camera. In FIG. 6B, device 302 determines that the front face of object 608 corresponds to device 302's field of view.

In some embodiments, in accordance with determining that a particular face of object 608 corresponds to device 302's field of view, device 302 provides audio output 612. Audio output 612 indicates the particular face of object 608, e.g., “front face of chair.” In some embodiments, device 302 provides audio output 612 using the speakable information included in a two-dimensional representation of object 608 corresponding to the particular face, as discussed above. Although audio outputs 610 and 612 are illustrated as separate outputs, in some embodiments, audio outputs 610 and 612 are combined into a single output. For example, responsive to detecting object 608, device 302 audibly outputs “front face of chair, 5 meters away.”

In some embodiments, in accordance with determining that a particular face of object 608 corresponds to device 302's field of view, device 302 displays visual element 614 indicating the particular face. In some embodiments, visual element 614 includes a cursor displayed on the particular face, a rectangle indicating the extent of the particular face, or other visual element to visually distinguish the particular face from the other faces of object 608.

FIG. 6C illustrates that the user has moved device 302 after provision of audio output 610 and/or 612. In accordance with detecting the movement, device 302 determines that object 608 does not appear device 302's field of view. In some embodiments, responsive to determining that object 608 does not appear in the field of view, device 302 provides audio output 616. Audio output 616 indicates that object 608 no longer appears in the field of view, e.g., “chair no longer detected.” In some embodiments, audio output 616 includes instructions for moving device 302 such that object 608 re-appears in device 302's field of view. In some embodiments, responsive to determining that object 608 does not appear in the field of view, device 302 additionally or alternatively provides a haptic output.

FIG. 6D illustrates that the user has moved device 302 relative to its location in FIG. 6C, e.g., forward and to the right. In some embodiments, device 302 provides audio output 618, e.g., after providing audio output(s) 606, 610, 612, or 616, or a combination or sub-combination thereof. Audio output 618 includes updated directions to object 608, e.g., the most recently detected virtual object. Device 302 determines the updated directions based on device movement, e.g., device 302's current location. In some embodiments, audio output 618 includes a distance between device 302 and object 608, directions to object 608, and/or the face of object 608 corresponding to device 302's field of view. For example, audio output 618 includes “front face of chair, two meters to your right.”

In some embodiments, device 302 periodically provides audio output 618, e.g., every seconds. In some embodiments, device 302 provides audio output 618 responsive to determining, based on device movement, that device 302 has moved a predetermined distance, e.g., 5 meters.

FIG. 6E illustrates that the user has moved device 302 relative to its location in FIG. 6D. For example, the user has turned to face the left side of environment 600. Display 402 thus provides a view including of the left side of environment 600 and the left face of object 608. In some embodiments, device 302 provides audio output 620 including updated directions to object 608. Audio output 620 includes the same information as, or information similar to, audio output 618. For example, audio output 620 includes “left face of chair, 3 meters away.”

FIG. 6F illustrates that the user has moved device 302 relative to its location in FIG. 6E to locate object 608. In some embodiments, the movement of device 302 (and the user) corresponds to a direction associated with a field of view device 302's one or more cameras. For example, in FIG. 6F, the user has moved forward (relative to FIG. 6E) in the direction of device 302's cameras. Device 302 determines, based on its detected movement, that object 608 has been located.

In some embodiments, determining that object 608 has been located includes determining that device 302 is within a predetermined distance (e.g., 1 meter, 0.5 meters, 0.1 meters) of object 608. In some embodiments, determining that object 608 has been located includes determining that device 302 is within the predetermined distance of object 608 for a predetermination duration, e.g., 1, 2, or 3 seconds.

In accordance with determining that object 608 has been located, device 302 provides audio output 622. Audio output 622 indicates that object 608 has been located, e.g., “found chair” or “you are next to the chair.” In some embodiments, after providing audio output 622, device 302 enables user input to interact with (e.g., modify, move, delete, get information about) object 608.

FIGS. 7A-C illustrate further accessible techniques for locating a virtual object, according to some embodiments. Generally, the techniques discussed with respect to FIGS. 7A-C differ from the techniques discussed with respect to FIGS. 6A-F by allowing a user to select a virtual object to locate, e.g., from a list of virtual objects. Upon user selection of a virtual object, device 302 may provide directions to the selected object, similarly to the techniques discussed above. In this manner, the techniques discussed below may not require a user to move device 302 to point the device camera at a virtual object to be located (e.g., as in FIGS. 6A-B above).

FIG. 7A illustrates device 302 presenting list 702 of virtual objects to locate. In some embodiments, list 702 is audibly provided and/or visually provided (e.g., displayed on display 402). In some embodiments, list 702 includes all virtual objects within a user's current environment, (e.g. a particular room). In some embodiments, the virtual objects in list 702 are sorted from closest to furthest from the user's current location, e.g., device 302's location. For example, list 702 includes the virtual objects “chair” and “box,” where the chair is closer to the user's location than the box is.

Turning to FIG. 7B, in some embodiments, responsive to user selection of an object from list 702 (e.g., via a touch gesture corresponding to the object's displayed user interface element), device 302 provides audio output 704. Audio output 704 includes directions to move device 302 to face the selected object, e.g., to move device 302 such that the selected object appears in device 302's field of view.

FIG. 7B illustrates device 302 in environment 700. Display 402 provides a view of environment 700 corresponding to device 302's field of view. Responsive to user selection of “box” in list 702, device 302 provides audio output 704 “move left to find the box.”

FIG. 7C illustrates that the user has moved device 302 according to audio output 704. Device 302 detects virtual object 710, e.g., the box. In some embodiments, responsive to detecting object 710, device 302 provides audio output 706 indicating detection of the virtual object, e.g., “box detected.” In some embodiments, audio output 706 includes information the same as, or similar to, audio output 610 or 612.

In some embodiments, responsive to detecting object 710, device 302 provides audio output 708. Audio output 708 includes directions to the selected object 710. Audio output 708 is determined based on the movement of device 302, e.g., device 302's current location. Audio output 708 includes information the same as, or similar to, the information provided by audio output 610 and/or 618. For example, audio output 708 includes “move 1 meter forward.” In some embodiments, similar to audio output 618, device 302 periodically provides audio output 708 and/or provides audio output 708 every time device 302 moves a predetermined distance.

In some embodiments, device 302 provides audio output 708 without providing audio outputs 704 and/or 706. For example, responsive to user selection of a virtual object from list 702, device 302 provides (e.g., periodically provides) audio output 708, regardless of whether a selected virtual object appears in device 302's field of view, e.g., is detected.

In some embodiments, based on detected device movement, e.g., according to audio output 708, device 302 determines that a selected virtual object has been located. In some embodiments, in accordance with determining that a selected virtual object has been located (e.g., determining that device 302 is within a predetermined distance from the selected virtual object, and optionally within the predetermined distance for a predetermined duration), device 302 provides audio output indicating the selected virtual object has been located and/or enables user input to interact with the selected virtual object.

The techniques discussed above with respect to FIGS. 6A-F and 7A-C may improve the accessibility of MR software applications involving locating virtual objects. For example, by providing the audio outputs discussed above, device 302 may continually guide a visually impaired user to a virtual object's location, (e.g., whereas sighted users may simply see where the virtual object is located). Further, by indicating that a virtual object has been located when the user (e.g. device 302) is physically near the virtual object's location, the techniques discussed above may meaningfully indicate the locations of virtual objects to non-sighted users, e.g., by associating a virtual object's location with a physical location.

FIGS. 8A-B illustrate accessible techniques for exploring a MR environment, according to some embodiments. Generally, the techniques discussed below may allow a user to explore a MR environment (or virtual objects within the environment) without moving about the environment (or with limited movement).

FIG. 8A illustrates device 302 in environment 800. Device 302 provides view 802 of environment 800 (including virtual object 804) on display 402. In some embodiments, view 802 corresponds to device 302's current field of view.

In some embodiments, view 802 corresponds to a particular object, such as virtual object 804. For example, device 302 allows a user to select a particular object, and responsive to user selection of the object, device 302 displays view 802. In some embodiments, view 802 corresponds to a predetermined face (e.g., front face) of the selected object, and includes a view of environment 800 from a perspective corresponding to the predetermined face. For example, view 802 includes the front face of object 804 and includes what a user would see if they were located, e.g., a predetermined distance in front of the front face of object 804. It should be appreciated that view 802 may not be device 302's field of view. For example, when view 802 is provided, virtual object 804 may or may not be in the field of view of device 302's one or more cameras.

In some embodiments, device 302 displays views 806, 808, 810, 812, 814, and 816, e.g., concurrently with view 802. In some embodiments, views 806-816 respectively correspond to different faces of virtual object 804 (e.g., front, left, right, back, top, and bottom) and respectively include views of environment 800 from perspectives corresponding to the respective face. For example, view 808 includes the user's perspective of environment 800 if the user were located a predetermined distance from the left face of object 804 and viewing the left face, view 810 includes the user's perspective of environment 800 if the user were located a predetermined distance from the right face of object 804 and viewing the right face, and so on. In some embodiments, device determines views 806-816 using a plurality of two-dimensional representations of virtual object 804, discussed above.

As shown in FIG. 8A, in some embodiments, views 806-816 respectively correspond to smaller (e.g., thumbnail) views of virtual object 804 from different perspectives corresponding to different faces. In some embodiments, view 802 is an enlarged version of one of views 806-816, e.g., view 806. In some embodiments, device 302 visually indicates the currently enlarged view, e.g., by highlighting view 806, or otherwise visually distinguishing view 806 from views 808, 810, 812, 814, and 816.

FIG. 8B illustrates device 302 in environment 800 responsive to user selection of view 808, e.g., through a touch gesture performed on view 808 (or through other means). In some embodiments, responsive to user selection of one of views 806-816, device 302 displays an enlarged version of the selected view. For example in FIG. 8B, the user has selected view 808 corresponding to the left face of object 804. Device 302 thus displays view 818, corresponding to an enlarged version of view 808.

In this manner, a user may select to view a virtual object (and the environment the virtual object is located) from different perspectives, e.g., regardless of whether the perspective corresponds a device's current field of view. This may improve the accessibility of exploring a MR environment by enabling exploration without requiring a user to physically move about to change a device's field of view.

FIGS. 9A-C illustrate accessible techniques for maintaining and updating a view of a MR environment, according to some embodiments.

FIG. 9A illustrates device 302 in environment 900. Device 302 (e.g., the device camera(s)) faces the left wall of environment 900. The bottom right corner of FIG. 9A shows view 906 of the environment provided on display 402. View 906 includes physical table 902 and virtual vase 904.

View 906 corresponds to a first pose of device 302 in FIG. 9A. In some embodiments, view 906 corresponds to the field of view of device 302 when device 302 is in the first pose. A “pose” of an electronic device refers to the location and orientation of the electronic device. Thus, a change in location and/or orientation of an electronic device changes the electronic device's pose.

The first pose may be unnatural and/or difficult for a user to maintain. For example, the first pose may correspond to device 302 being held in an uncomfortable position (e.g., arm raised in front of the user, arm raised to the side of the user, arm bent in an awkward position, etc.) or the user holding a uncomfortable head pose (e.g., if device 302 is a HMD). However, view 906 corresponding to the first pose may be of user interest. For example, view 906 may include physical or virtual elements (e.g., vase 904) that the user desires to interact with.

In some embodiments, device 302 receives user input to maintain view 906 while displaying view 906. In some embodiments, the user input is received audibly (e.g., through a voice command), via interaction with a displayed graphical element, via a user gesture associated with device 302 (e.g., a swipe gesture performed on display 402, a gesture moving device 302, a press of a button of device 302), or via input at an external device (e.g., mouse or joystick) coupled to device 302. In response to receiving the user input to maintain view 906, device 302 maintains view 906. In some embodiments, maintaining a view includes not updating/changing at least the physical content of the view, e.g., when device 302 moves. In some embodiments, maintaining a view includes not updating or changing any content (physical or virtual) of the view, e.g., when device 302 moves. For example, responsive to receiving the user input, device 302 no longer updates view 906 to correspond to the field of view of device 302.

FIG. 9B illustrates that device 302 maintains view 906 when device 302 moves from the first pose to a second pose. In FIG. 9B, device 302 has moved from the first pose of FIG. 9A to a second pose where the device faces the front wall of environment 900. In some embodiments, the second pose corresponds to another view of environment 900, e.g., device 302's field of view when the device is in the second pose. However, because view 906 is maintained, view 906 is displayed without displaying the view corresponding to the second pose.

The second pose may be more comfortable and/or natural for a user to maintain than the first pose. For example, the second pose may correspond to a lowered arm position (e.g., how users typically hold and/or view a smartphone) or a more comfortable head position. Accordingly, maintaining view 906 while device 302 is in the second pose may advantageously allow comfortable user interaction with displayed content otherwise inaccessible in the second pose (e.g., inaccessible because the content of interest does not correspond to device 302's current field of view). For example, device 302's field of view in FIG. 9B corresponding to the second pose does not include vase 904.

In some embodiments, while maintaining view 906, device 302 enables user input to interact with a virtual object. In some embodiments, the virtual object is included in view 906 (e.g., vase 904). In some embodiments, the user may provide input to generate a virtual object to include in view 906. In some embodiments, user input to interact with the virtual object is subject to one or more constraints associated with one or more physical and/or virtual elements in view 906. For example, device 302 enables user input to move or place vase 904 only on physical surfaces represented in view 906 (e.g., on table 902 or on the floor). As another example, device prohibits user input to place vase 904 such that it overlaps with an extent of another physical or virtual object in view 906. Accordingly, in some embodiments, device 302 not only captures a “screenshot” of maintained view 906, but also determines additional information representing the physical and/or virtual content of view 906, where such information constrains interaction with the view according to one or more physical laws.

In some embodiments, device 302 receives user input to enter a virtual reality (VR) mode. In some embodiments, the user input is received while the electronic device is in the second pose (FIG. 9B). In some embodiments, the user input to enter the VR mode is received audibly, via interaction with a displayed graphical element, via a user gesture associated with device 302, or via input at an external device coupled to device 302. In some embodiments, in response to receiving the user input to enter the VR mode, device 302 ceases maintaining view 906 and updates view 906 according to the techniques discussed below. The updating of view 906 may be considered VR because the updated views may not be device 302's physical field of view, but may comport with inputs received at device 302 (e.g., pose changes of the device) according to physical laws. As discussed in greater detail below with respect to FIG. 9C, in the VR mode, the user may interact with the previously maintained view based on movement from a current pose (e.g., second pose) different from the pose (e.g., first pose) that allowed device 302 to capture the previously maintained view.

FIG. 9C illustrates movement of device 302 from the second pose of FIG. 9B to a third pose, e.g., after receiving user input to enter the VR mode. In FIG. 9C, device 302 moves forward towards the front wall of environment 900 relative to FIG. 9B. Device 302 detects such movement from the second pose to the third pose.

Device 302 determines its virtual pose based on such movement relative to the first pose. In some embodiments, the virtual pose of device 302 is the pose device 302 would have if the device were moved according to such movement (from the second pose to the third pose), but were in the first pose of FIG. 9A. Accordingly, in some embodiments, determining the virtual pose includes determining a relative movement of device 302 from the second pose to the third pose (e.g., as a vector or vector sequence), and applying the relative movement to the first pose to obtain the virtual pose. For example, the relative movement of device 302 from FIG. 9B to 9C is forward towards the front wall. Applying this forward movement to the first pose of FIG. 9A results in a virtual pose that remains oriented towards the left wall, but is closer to the left wall (as “forward” relative to the first pose results in a virtual pose closer to the left wall). As another example, if device 302 moves from the second pose (FIG. 9B) and turns to face the right side of environment 900 (a fourth pose), applying the relative movement from the second pose to the fourth pose to the first pose would result in a virtual pose facing the front side of environment 900 (as turning right relative to the first pose results in a virtual pose facing the front wall).

In FIG. 9C, device 302 updates view 906 to display view 908. View 908 corresponds to the determined virtual pose. For example, view 908 corresponds to device 302's field of view if the device was physically in the virtual pose, e.g., even though device 302 is physically in the third pose in FIG. 9C. In the example of FIG. 9C, view 908 includes what would be displayed to a user had the user/device stepped forward from the pose in FIG. 9A towards the left wall. In some embodiments, device 302 generates view 908 using predetermined information associated with environment 900, e.g., determined from view 906 and/or from prior scan data of the environment.

In this manner, device 302 may transition from a MR mode (e.g., where the displayed view at least partially corresponds to the device's field of view) to a VR mode, thereby enabling updating of a previously maintained MR view (e.g., view 906) according to VR techniques. As discussed, such maintaining and updating of a MR view may improve user comfort and convenience when exploring MR environments.

FIG. 10 illustrates a flow diagram of process 1000 for scanning an environment and for placing virtual objects in a MR environment, according to some embodiments. In some embodiments, process 1000 is performed using system 390, and the blocks of process 1000 are divided up in any manner between the components of system 390 (e.g., device 302 and controller 304). In other embodiments, process 1000 is performed using only device 302. In process 1000, some blocks are, optionally, combined, the order of some blocks is, optionally, changed, and some blocks are, optionally, omitted. In some embodiments, additional steps may be performed in combination with process 1000.

Generally, process 1000 is illustrated using FIGS. 4A-K and 5A-C, discussed above. However, it should be appreciated that other Figures discussed above may be equally applicable to process 1000.

At block 1002, while detecting first movement of an electronic device, an environment is scanned with one or more sensors of the electronic device (e.g., device 302). The environment includes a plurality of features of a first type. In some embodiments, the features of the first type include vertical planes and horizontal planes of the environment. In some embodiments, scanning the environment includes detecting, with the one or more sensors, a first feature of the plurality of features. In some embodiments, detecting the first feature includes displaying a visual element (e.g., visual element 412) adjacent to the detected first feature.

In some embodiments, prior to scanning the environment, an audio output (e.g., audio output 408) instructing a user to move the electronic device to scan the environment is provided, where the audio output instructing the user to move the electronic device indicates at least one of: a number of features of the plurality of features to be scanned; and an area of the environment to be scanned.

At block 1004, it is determined whether a first feature of the plurality of features is detected. In some embodiments, in accordance with determining that the first feature is detected (block 1004 YES), process 1000 proceeds to block 1006. In some embodiments, in accordance with determining that the first feature is not detected (block 1004 NO), process 1000 returns to block 1002 and the environment continues to be scanned.

At block 1006, while scanning the environment, a first audio output (e.g., audio output 410, 416, or 420) indicating the detection of the first feature is provided. In some embodiments, the first audio output indicates an identity of the first feature.

At block 1008, while scanning the environment, a second audio output (e.g., audio output 418 or 422) indicating a progress of the scanning is provided. In some embodiments, the second audio output indicates at least one of: a number of detected features of the plurality of features; and a total area associated with the detected features of the plurality of features. In some embodiments, providing the second audio output includes periodically providing the second audio output.

In some embodiments, it is determined that a second feature of the plurality of features has not been detected within a predetermined duration after detecting the first feature. In some embodiments, in accordance with determining that the second feature has not been detected within the predetermined duration: an audio output instructing a user to move the electronic device (e.g., audio output 414) is provided.

In some embodiments, it is determined that the scanning of the environment is complete. In some embodiments, in accordance with determining that the scanning of the environment is complete, an audio output indicating a completion of the scanning (e.g., audio output 424) is provided. In some embodiments, determining that the scanning of the environment is complete includes determining that a predetermined number of features of the plurality of features have been detected. In some embodiments, determining that the scanning of the environment is complete includes determining that an area associated with detected features of the plurality of features exceeds a threshold area.

At block 1010, a first view (e.g., view 426 in FIG. 4E) of the environment is displayed. The first view includes a virtual object (e.g., object 428) displayed at a first location on a first surface of the environment, the first location corresponding to a current location of the electronic device. In some embodiments, the first surface is a bottom surface of the environment. In some embodiments, the environment is a physical environment. In some embodiments, the first view is displayed from a perspective corresponding to the current location.

At block 1012, movement of the electronic device from the current location to an updated location is detected (e.g., the movement of the electronic device from FIG. 4E to FIG. 4J).

At block 1014, in accordance with detecting the movement from the current location to the updated location, a second view (e.g., view 426 in FIG. 4J) of the environment is displayed. The second view includes the virtual object displayed at a second location on the first surface of the environment, the second location corresponding to the updated location. In some embodiments, the second view is displayed from a perspective corresponding to the updated location.

In some embodiments, it is determined that the virtual object cannot be placed at a particular location where the virtual object is displayed. In some embodiments, in response to determining that the virtual object cannot be placed at the particular location, an audio output (e.g., audio output 430) indicating that the virtual object cannot be placed at the particular location is provided. In some embodiments, determining that the virtual object cannot be placed at the particular location includes determining that an extent of the virtual object, when placed at the particular location, overlaps with an extent of another object in the environment.

In some embodiments, movement of the electronic device from the current location to a third updated location (e.g., the location of device 302 in FIG. 4H) is detected. In some embodiments, the third updated location is above a second surface of the environment and the second surface is above the first surface. In some embodiments, in accordance with detecting movement of the electronic device from the current location to the third updated location: a fourth view (e.g., view 426 in FIG. 4H) of the environment from a perspective corresponding to the third updated location is displayed. The fourth view includes the virtual object displayed at a third location corresponding to the third updated location, where the third location is on the second surface. In some embodiments, in accordance with detecting movement of the electronic device from the current location to the third updated location, an audio output (e.g., audio output 432) indicating that the virtual object has changed surfaces is provided.

In some embodiments, after displaying the fourth view of the environment, movement of the electronic device (e.g., movement of device 302 from FIG. 4H to FIG. 4I) above the second surface is detected. In some embodiments, while detecting the movement of the electronic device above the second surface, the fourth view is updated to display the virtual object at a plurality of locations corresponding to the movement of the electronic device above the second surface, each location of the plurality of locations being on the second surface (e.g., the location of object 428 in FIG. 4I).

At block 1016, it is determined whether user input to place the virtual object is received. In some embodiments, in accordance with determining that the user input is received (block 1016 YES), in response to receiving the user input, process 1000 proceeds to block 1018. In some embodiments, in accordance with determining that the user input is not received, process 1000 returns to block 1012, e.g., device movement continues to be detected and views of the environment are updated according to the device movement.

At block 1018, the virtual object is placed at the second location (e.g., object 428's location in FIG. 4J). In some embodiments, placing the virtual object at the second location includes at least one of: providing an audio output (e.g., audio output 436) indicating the placement of the virtual object; and providing an audio output indicating a position of the virtual object relative to another object in the environment.

In some embodiments, after placing the virtual object at the second location, movement of the electronic device from the updated location to a second updated location (e.g., the movement of device from FIG. 4J to 4K) is detected. In some embodiments, in accordance with detecting the movement of the electronic device from the updated location to the second updated location: a third view of the environment from a perspective corresponding to the second updated location (e.g., view 426 in FIG. 4K) is displayed. The third view includes the virtual object displayed at the second location.

The operations described above with reference to FIG. 10 are optionally implemented by components depicted in FIGS. 3A-B. For example, the operations of process 1000 may be implemented by device 302 and/or controller 304, or any component(s) thereof. It would be clear to a person having ordinary skill in the art how other processes are implemented based on the components depicted in FIGS. 3A-B.

Note that details of process 1000 described above with respect to FIG. 10 are also applicable in an analogous manner to process 1100 described below. For example, process 1100 optionally includes one or more of the characteristics of process 1000 discussed above. For example, prior to performing techniques for locating virtual objects in a MR environment (e.g., process 1100), a device may perform accessible techniques for scanning the MR environment, as discussed above. For brevity, these details are not repeated below.

FIG. 11 illustrates a flow diagram of process 1100 for locating virtual objects in a MR environment, according to some embodiments. In some embodiments, process 1100 is performed using system 390, and the blocks of process 1100 are divided up in any manner between the components of system 390 (e.g., device 302 and controller 304). In other embodiments, process 1100 is performed using only device 302. In process 1100, some blocks are, optionally, combined, the order of some blocks is, optionally, changed, and some blocks are, optionally, omitted. In some embodiments, additional steps may be performed in combination with process 1100.

Generally, process 1100 is illustrated using FIGS. 6A-F, 7A-D, and 8A-B, discussed above. However, it should be appreciated that other Figures discussed above may be equally applicable to process 1100.

At block 1102, a virtual object (e.g., object 608) is detected for. In some embodiments, prior to detecting the virtual object, a third audio output (e.g., audio output 606) instructing a user to move an electronic device such that the virtual object appears in a field of view of a camera of the electronic device is provided. In some embodiments, the virtual object is an object of a plurality of virtual objects in an environment and the virtual object is the closest object, of the plurality of virtual objects in the environment, to the electronic device.

At block 1104, it is determined whether a virtual object is detected. In some embodiments, in accordance with determining that the virtual object is detected (block 1104 YES), process 1100 proceeds to block 1106. In some embodiments, detecting the virtual object includes determining that the virtual object appears in the field of view of the camera. In some embodiments, in accordance with determining that the virtual object is not detected (block 1104 NO), process 1100 returns to block 1102, e.g., a device continues to detect for the virtual object.

At block 1106, in response to detecting the virtual object, audio output (e.g., audio output 610) indicating an identity of the virtual object and a distance between the virtual object and the electronic device is provided. In some embodiments, the audio output further indicates a direction of the virtual object relative to the electronic device.

In some embodiments, in response to detecting the virtual object, a haptic output is provided. In some embodiments, an intensity of the haptic output is based on a distance between the electronic device and the virtual object.

In some embodiments, the virtual object includes a plurality of faces and it is determined that a particular face of the virtual object, of the plurality of faces, corresponds to the field of view of the camera. In accordance with determining that the particular face of the virtual object corresponds to the field of view of the camera, a fourth audio output (e.g., audio output 612) indicating the particular face of the virtual object is provided. In some embodiments, in accordance with determining that the particular face of the virtual object corresponds to the field of view of the camera, a visual element (e.g., visual element 614) indicating the particular face of the virtual object is displayed.

In some embodiments, after providing the audio output, second movement of the electronic device (e.g., the movement of device 302 from FIG. 6B to 6C) is detected. In accordance with detecting the second movement, it is determined that the virtual object does not appear in the field of view of the camera. Responsive to determining that the virtual object does not appear in the field of view, a second audio output (e.g., audio output 616) is provided.

In some embodiments, after providing the audio output, and before providing an audio output indicating that the virtual object has been located, a fifth audio output (e.g., audio output 618) including updated directions to the virtual object is provided. The updated directions are determined based on the movement of the electronic device. In some embodiments, providing the fifth audio output includes periodically providing the fifth audio output. In some embodiments, providing the fifth audio output includes providing the fifth audio output responsive to a determination, based on the movement of the electronic device, that the electronic device has moved a second predetermined distance.

At block 1108, after providing the audio output, movement of the electronic device is detected (e.g., movement of device 302 from FIG. 6B to FIG. 6F). In some embodiments, the movement of the electronic device corresponds to a direction associated with the field of view of the camera.

At block 1110, it is determined, based on the detected movement of the electronic device, whether the electronic device is within a predetermined distance of the virtual object. In some embodiments, in accordance with determining that the electronic device is not within a predetermined distance of the virtual object (block 1110 NO), process 1100 returns to block 1108, e.g., device movement continues to be detected. In some embodiments, in accordance with determining that the electronic device is within the predetermined distance of the virtual object, process 1100 proceeds to block 1112.

At block 1112, an output (e.g., output 622) indicating that the virtual object has been located is provided. In some embodiments, after providing the output indicating that the virtual object has been located, user input to edit the virtual object is enabled.

The operations described above with reference to FIG. 11 are optionally implemented by components depicted in FIGS. 3A-B. For example, the operations of process 1100 may be implemented by device 302 and/or controller 304, or any component(s) thereof. It would be clear to a person having ordinary skill in the art how other processes are implemented based on the components depicted in FIGS. 3A-B.

Note that details of process 1100 described above with respect to FIG. 11 are also applicable in an analogous manner to process 1200 described below. For example, process 1200 optionally includes one or more of the characteristics of process 1100 discussed above. For example, when a virtual object appears in a device's field of view in process 1200, the device may provide various audible information associated with the virtual object according to the techniques discussed with respect to process 1100. For brevity, these details are not repeated below.

FIG. 12 illustrates a flow diagram of process 1200 for maintaining and updating a view of a MR environment, according to some embodiments. In some embodiments, process 1200 is performed using system 390, and the blocks of process 1200 are divided up in any manner between the components of system 390 (e.g., device 302 and controller 304). In other embodiments, process 1200 is performed using only device 302. In process 1200, some blocks are, optionally, combined, the order of some blocks is, optionally, changed, and some blocks are, optionally, omitted. In some embodiments, additional steps may be performed in combination with process 1200.

Generally, process 1200 is illustrated using FIGS. 9A-C discussed above. However, it should be appreciated that other Figures discussed above may be equally applicable to process 1200.

At block 1202, a first view (e.g., view 906) of a mixed reality (MR) environment is displayed. The first view of the MR environment corresponds to a first pose of an electronic device.

At block 1204, it is determined whether user input to maintain the first view is received while displaying the first view. In some embodiments, in accordance with determining that the user input to maintain the first view is not received (block 1204 NO), process 1200 returns to block 1202. For example, the first view is displayed and/or updated according to device movement. In some embodiments, in accordance with determining that the user input to maintain the first view is received, process 1200 proceeds to block 1206.

At block 1206, in response to receiving the user input, the first view is maintained when the electronic device moves from the first pose to a second pose (e.g., the movement of device 302 from FIG. 9A to 9B). In some embodiments, the second pose corresponds to a third view of the MR environment and maintaining the first view includes displaying the first view without displaying the third view. In some embodiments, maintaining the first view includes: not updating at least a physical content of the first view while the electronic device is in the second pose and not updating at least the physical content of the first view prior to detecting a first movement of the electronic device. In some embodiments, maintaining the first view includes not updating at least a physical content of the first view when the electronic device moves.

In some embodiments, the first view includes a virtual object (e.g., vase 904) and the virtual object is not in the field of view of the electronic device when the electronic device is in the second pose.

In some embodiments, the first view includes a virtual object (e.g., vase 904), and while maintaining the first view, user input to interact with the virtual object is enabled. In some embodiments, the first view includes one or more physical elements of the MR environment and enabling user input to interact with the virtual object includes enabling interaction with the virtual object subject to a constraint associated with the one or more physical elements.

At block 1208, it is determined whether user input to enter a virtual reality (VR) mode is received. In some embodiments, in accordance with determining that the user input to enter the VR mode is not received, process 1200 returns to block 1206. For example, the first view continues to be maintained. In some embodiments, in accordance with determining that the user input to enter the VR mode is received, process 1200 proceeds to block 1210.

At block 1210, first movement of the electronic device from the second pose to a third pose is detected (e.g., the movement of device 302 from FIG. 9B to 9C).

At block 1212, a virtual pose of the electronic device is determined based on the first movement of the electronic device relative to the first pose. In some embodiments, determining the virtual pose includes determining a relative movement of the electronic device from the second pose to the third pose and applying the relative movement to the first pose to obtain the virtual pose.

At block 1214, the first view is updated to display a second view (e.g., view 908) of the MR environment, the second view corresponding to the virtual pose. In some embodiments, displaying the second view includes displaying the second view while the electronic device is in the third pose. In some embodiments, updating the first view to display the second view is performed in response to receiving the user input to enter the VR mode.

The operations described above with reference to FIG. 12 are optionally implemented by components depicted in FIGS. 3A-B. For example, the operations of process 1200 may be implemented by device 302 and/or controller 304, or any component(s) thereof. It would be clear to a person having ordinary skill in the art how other processes are implemented based on the components depicted in FIGS. 3A-B.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A non-transitory computer-readable storage medium storing one or more programs, the one or more programs comprising instructions, which when executed by one or more processors of an electronic device with a display, cause the electronic device to:
display a first view of a mixed reality (MR) environment, the first view corresponding to a first pose of the electronic device;
while displaying the first view, receive user input to maintain the first view;
in response to receiving the user input, maintain the first view when the electronic device moves from the first pose to a second pose;
detect first movement of the electronic device from the second pose to a third pose;
determine a virtual pose of the electronic device based on the first movement of the electronic device relative to the first pose; and
update the first view to display a second view of the MR environment, the second view corresponding to the virtual pose.

2. The non-transitory computer-readable storage medium of claim 1, wherein:
the second pose corresponds to a third view of the MR environment; and
maintaining the first view includes displaying the first view without displaying the third view.

3. The non-transitory computer-readable storage medium of claim 1, wherein maintaining the first view includes:
not updating at least a physical content of the first view while the electronic device is in the second pose; and
not updating at least the physical content of the first view prior to detecting the first movement.

4. The non-transitory computer-readable storage medium of claim 1, wherein maintaining the first view includes not updating at least a physical content of the first view when the electronic device moves.

5. The non-transitory computer-readable storage medium of claim 1, wherein the first view includes a virtual object, and wherein the one or more programs further comprise instructions, which when executed by the one or more processors, cause the electronic device to:
while maintaining the first view, enable user input to interact with the virtual object.

6. The non-transitory computer-readable storage medium of claim 5, wherein:
the first view includes one or more physical elements of the MR environment; and
enabling user input to interact with the virtual object includes enabling interaction with the virtual object subject to a constraint associated with the one or more physical elements.

7. The non-transitory computer-readable storage medium of claim 1, wherein:
the first view includes a virtual object; and
the virtual object is not in the field of view of the electronic device when the electronic device is in the second pose.

8. The non-transitory computer-readable storage medium of claim 1, wherein the one or more programs further comprise instructions, which when executed by the one or more processors, cause the electronic device to:
receive user input to enter a virtual reality (VR) mode, wherein updating the first view to display the second view is performed in response to receiving the user input to enter the VR mode.

9. The non-transitory computer-readable storage medium of claim 1, wherein determining the virtual pose includes:
determining a relative movement of the electronic device from the second pose to the third pose; and
applying the relative movement to the first pose to obtain the virtual pose.

10. The non-transitory computer-readable storage medium of claim 1, wherein displaying the second view includes displaying the second view while the electronic device is in the third pose.

11. An electronic device, comprising:
a display;
one or more processors;
a memory; and
one or more programs, wherein the one or more programs are stored in the memory and configured to be executed by the one or more processors, the one or more programs including instructions for:
displaying a first view of a mixed reality (MR) environment, the first view corresponding to a first pose of the electronic device;
while displaying the first view, receiving user input to maintain the first view;
in response to receiving the user input, maintaining the first view when the electronic device moves from the first pose to a second pose;
detecting first movement of the electronic device from the second pose to a third pose;
determining a virtual pose of the electronic device based on the first movement of the electronic device relative to the first pose; and
updating the first view to display a second view of the MR environment, the second view corresponding to the virtual pose.

12. A method comprising:
at an electronic device with a display:
displaying a first view of a mixed reality (MR) environment, the first view corresponding to a first pose of the electronic device;
while displaying the first view, receiving user input to maintain the first view;
in response to receiving the user input, maintaining the first view when the electronic device moves from the first pose to a second pose;
detecting first movement of the electronic device from the second pose to a third pose;
determining a virtual pose of the electronic device based on the first movement of the electronic device relative to the first pose; and
updating the first view to display a second view of the MR environment, the second view corresponding to the virtual pose.
